(19) United States
(12) Patent Application Publication
(10) Pub. No.: US 2026/0253591 A1
(43) Pub. Date: Aug. 27, 2026

(54) Methods And Systems For Detecting Sub-Vocal Speech Using Wearable Devices

(71) Applicant: Meta Platforms Technologies, LLC, Menlo Park, CA (US)

(72) Inventors: Emily Mittag Mugler, Seattle, WA (US); Andrew Maimone, Duvall, WA (US); Chuming Zhao, Redmond, WA (US); Nava K. Balsam, Woodinville, WA (US); Joshua Chartier, Mammoth Lakes, CA (US); Emanuele Formento, San Francisco, CA (US); Yinan Xuan, Bellevue, WA (US)

(21) Appl. No.: 19/550,171

(22) Filed: Feb. 25, 2026

Related U.S. Application Data
(60) Provisional application No. 63/762,845, filed on Feb. 25, 2025.

(51) Int. Cl. G10L 15/25; G10L 15/16; G10L 15/22

(52) U.S. Cl. CPC G10L 15/25; G10L 15/16; G10L 15/22; G10L 2015/223

(57) ABSTRACT

An example method of detecting speech includes receiving signals from one or more sensors of a wearable device worn by a user. The one or more sensors are configured to contact the head or face of the user and to detect at least one of the muscle contractions or vibrations associated with articulatory activity by the user. The method also includes determining speech corresponding to articulatory activity by the user based on the signals from the one or more sensors. For example, a user wearing smart glasses may silently mouth a command without producing audible sound, and the smart glasses may determine the speech based on muscle contractions and/or vibrations associated with the user's articulatory activity.

### RELATED APPLICATION

This application claims priority to U.S. Provisional Application Ser. No. 63/762,845, filed Feb. 25, 2025, entitled “Sub-Vocal Speech Detection on Smart Glasses,” which is incorporated herein by reference.

### TECHNICAL FIELD

This relates generally to speech detection systems for wearable devices and more particularly to methods and devices for detecting sub-vocal speech using sensors disposed in a wearable device.

### BACKGROUND

Wearable computing devices are becoming increasingly prevalent in consumer markets. These devices sometimes incorporate voice-based interfaces that allow users to interact with the devices through speech recognition systems. Voice interaction provides a natural and efficient method for users to communicate with their devices, particularly when traditional input methods like keyboards or touchscreens are impractical or unavailable.

Conventional speech recognition systems rely on audible speech captured through microphones. However, these conventional voice interaction systems have limitations. In public settings, users may feel uncomfortable speaking aloud to their devices due to social considerations or privacy concerns. Additionally, background noise in crowded or noisy environments can interfere with accurate speech recognition, reducing the effectiveness of voice-based interfaces. As a result, conventional speech recognition systems may struggle to distinguish between intended user commands and background conversations or ambient noise. This can lead to unintended activations, misinterpretation of commands, or failure to recognize legitimate voice inputs. These limitations can hinder user adoption and satisfaction with voice-enabled wearable devices.

### SUMMARY

The present disclosure describes, amongst other things, techniques for understanding what a user of a wearable device is saying when the user is whispering, or silently mouthing inputs. The wearable devices may include multiple types of sensors, such as sensors that detect muscle activity in the face and jaw, sensors that pick up vibrations through contact with the skin, motion sensors, and traditional microphones. The system may determine how the wearer is speaking (e.g., out loud, whispering, or silently) and what the surrounding environment is like (e.g., quiet or noisy), and then select sensors for that situation. In some cases, if the wearer is in a noisy subway, the system may rely on sensors that detect muscle movements rather than microphones that would pick up too much background noise. In some cases, if the wearer is silently mouthing a message in a library, the system may use sensors that detect the subtle muscle activity involved in forming words, even though no sound is produced. This sensor switching can allow the device to accurately understand the wearer regardless of how quietly they communicate.

In accordance with some embodiments, a method determining an utterance of a wearer of a wearable device includes obtaining sensor data via a plurality of sensors of the wearable device. The method also includes, based on the sensor data, determining one or more characteristics associated with articulatory activity from the wearer of the wearable device. The one or more characteristics include a type of articulatory activity (e.g., sub-vocal speech, mouthed speech, whispered speech), an environmental noise level, or a signal-to-noise ratio (SNR) of the sensor data. The method further includes selecting, based on the one or more characteristics, at least one sensor of the plurality of sensors. For example, responsive to determining that the articulatory activity is sub-vocal speech, one or more neuromuscular electrodes are selected; responsive to determining that the articulatory activity is whispered speech, one or more contact microphones are selected. The method also includes determining, based on sensor data from the at least one sensor and the one or more characteristics, an utterance of the wearer.

In accordance with some embodiments, a method of detecting speech includes: (i) receiving, by one or more processors, signals from one or more sensors of a wearable device worn by a user, where the one or more sensors are configured to contact a head or face of the user and to detect at least one of muscle contractions or vibrations associated with articulatory activity by the user; and (ii) determining, by the one or more processors, speech corresponding to the articulatory activity by the user based on the signals from the one or more sensors. For example, a user wearing a pair of smart glasses may silently mouth a command, such as “text Steve to pack his soccer gear,” without producing audible sound, and the smart glasses may determine the speech based on signals from neuromuscular electrodes and/or contact microphones that detect muscle contractions or vibrations associated with the user's articulatory activity.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1H illustrate examples of wearable devices detecting sub-vocal speech, in accordance with some embodiments.

FIG. 2 illustrates an example head-wearable device, in accordance with some embodiments.

FIG. 3 illustrates a flow diagram of a method of detecting sub-vocal speech, in accordance with some embodiments.

FIGS. 4A, 4B, 4C-1, and 4C-2 illustrate example MR and AR systems, in accordance with some embodiments.

In accordance with common practice, the various features illustrated in the drawings are not drawn to scale. Accordingly, the dimensions of the various features are arbitrarily expanded or reduced for clarity. In addition, some of the drawings do not depict all of the components of a given system, method, or device. Finally, like reference numerals are used to denote like features throughout the specification and figures.

### DETAILED DESCRIPTION

Users of wearable devices may wish to provide speech input without speaking aloud. For example, a user wearing smart glasses in a quiet library may want to send a text message without disturbing others. As another example, a user on a crowded subway may want to interact with an artificial intelligence assistant without others overhearing the conversation. In these situations, the user may whisper, silently mouth words, or engage in sub-vocal speech in which the user produces muscle movements associated with speech without producing audible sound.

The present disclosure describes techniques for detecting speech from a user of a wearable device by detecting at least one of muscle contractions or vibrations associated with articulatory activity. For example, sensors disposed in a frame of a pair of smart glasses may contact the user's head or face and detect electrical signals from facial muscles or vibrations transmitted through the user's skin during speech production. By detecting muscle contractions or vibrations rather than relying solely on acoustic signals, the techniques described herein may enable accurate speech recognition even when the user is whispering, silently mouthing words, or engaging in sub-vocal speech. Additionally, these techniques may improve speech recognition in noisy environments where acoustic microphones would be overwhelmed by background noise, and may provide enhanced privacy by enabling users to communicate with their devices without producing audible sound.

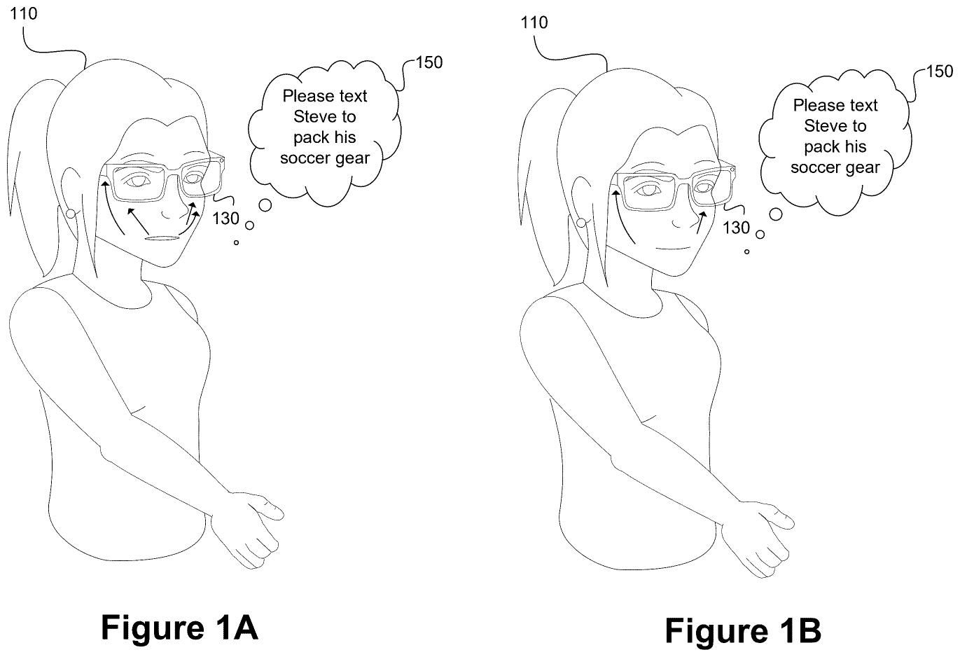

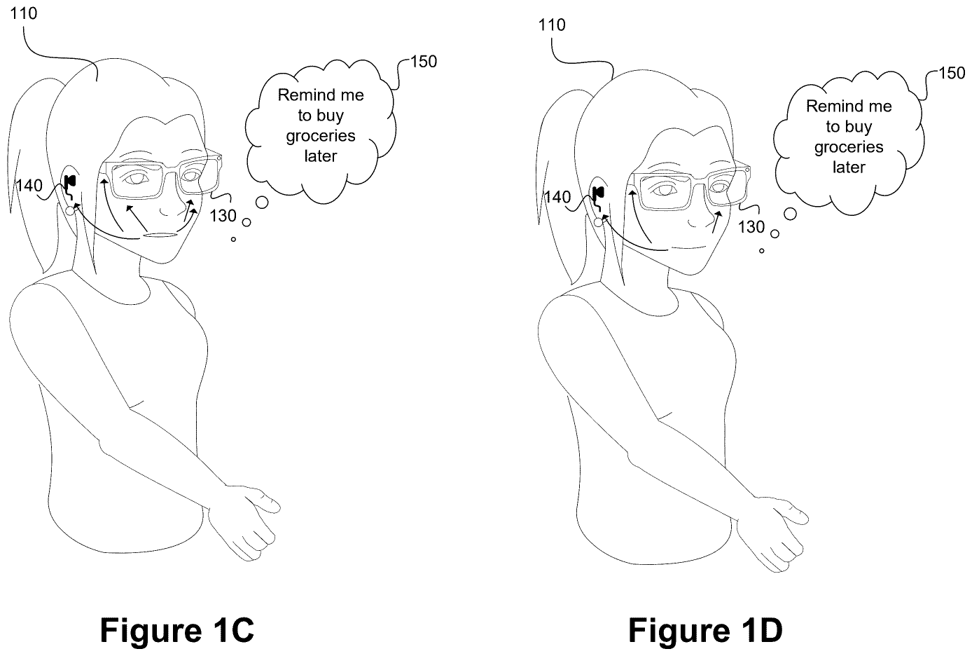

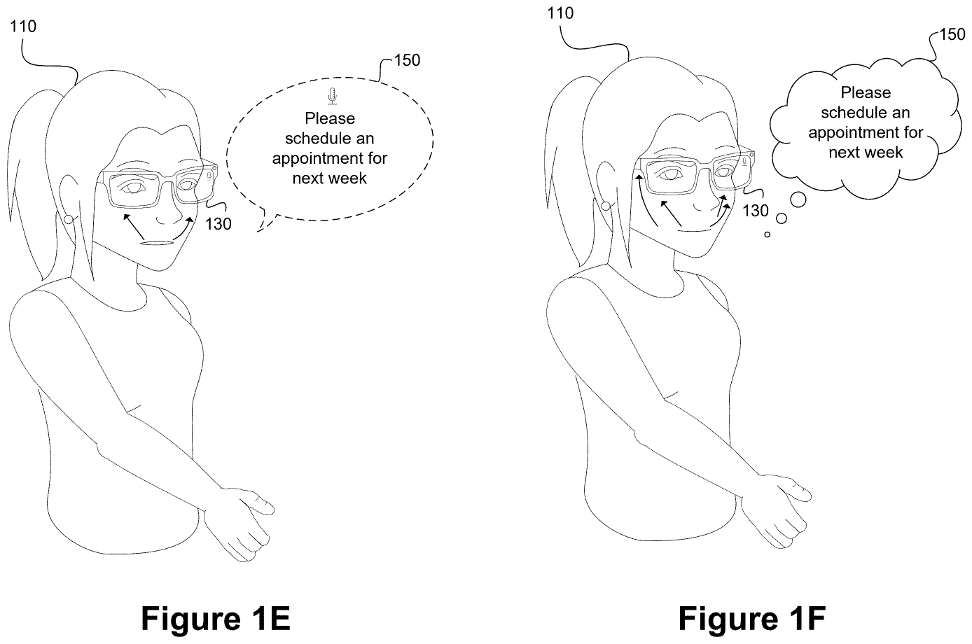

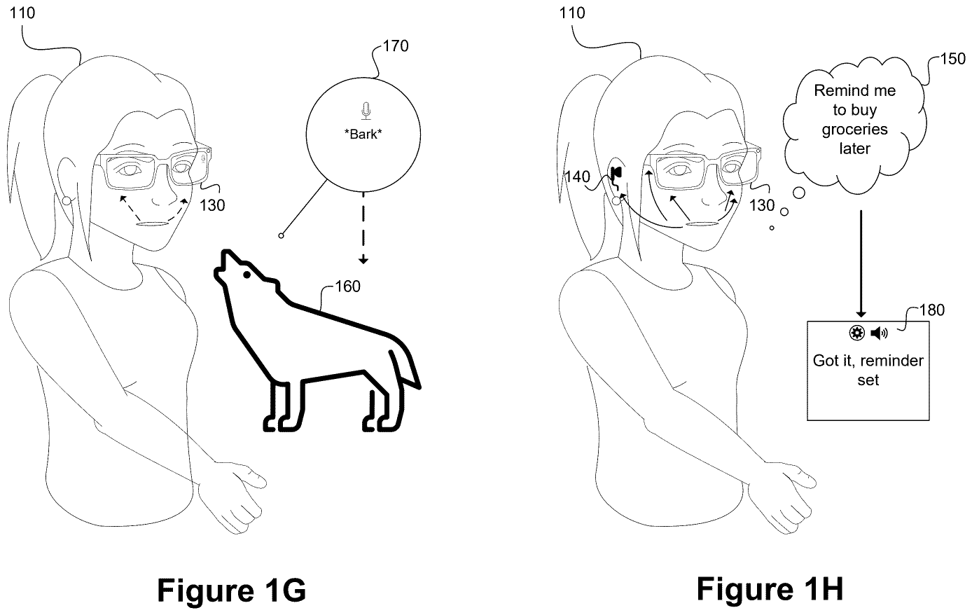

In the following, an overview of XR systems is provided, including MR and AR systems that may employ the sub-vocal and quiet speech detection techniques described herein. Next, techniques for recognizing indistinctly quiet, inaudible, and/or imperceptible speech inputs at wearable devices are described (e.g., with reference to FIGS. 1A-1H, 2, and 3), including description of the various types of articulatory activity and the sensors used to detect such activity. Example XR systems are then described (e.g., with reference to FIGS. 4A, 4B, 4C-1, and 4C-2), including AR and MR systems that may be used in conjunction with the speech detection techniques. The integration of artificial intelligence with XR systems is discussed, followed by example AR and MR interactions that illustrate how users may interact with these systems, e.g., using sub-vocal or quiet speech input. Finally, other interactions and device configurations that may employ the sub-vocal and quiet speech detection techniques are described.

Numerous details are described herein to provide a thorough understanding of the example embodiments illustrated in the accompanying drawings. However, some embodiments can be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as MR and AR systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

A voice input, as described herein, can include overt speech, quiet speech, whispered speech, mouthed speech, sub-vocal speech, and/or other articulatory activity that can be detected and determined based on signals from one or more sensors of a wearable device (e.g., neuromuscular electrodes, contact microphones, inertial measurement units (IMUs), and/or acoustic microphones of a head-wearable device, an ear-wearable device, or other wearable device configured to contact a head or face of the user). “Overt speech” generally includes speech in which the user's larynx is active and produces audible sound at typical conversational volume levels. “Quiet speech” generally includes speech produced at a volume level below typical conversational speech, such as whispered speech where there is no vibration of the user's vocal cords. “Mouthed speech” generally includes articulatory activity involving visible mouth movement without airflow or audible sound. “Sub-vocal speech” generally includes articulatory activity that does not produce audible sound and involves muscle contractions that may be imperceptible to visual observation. The different voice inputs disclosed herein can be detected using sensor data (e.g., neuromuscular signals sensed by one or more biopotential sensors (e.g., EMG sensors), vibrations sensed by contact microphones or IMU sensors, and/or acoustic signals sensed by microphones) detected by a wearable device worn by the user and/or other electronic devices communicatively coupled to the wearable device.

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product does not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above occur as a result of specific hardware. The devices described are not limiting, and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that can be used interchangeably or specifically required by embodiments described herein. For example, a processor can be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices can be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that can be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which can be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which are small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO2) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Sub-Vocal Speech Recognition

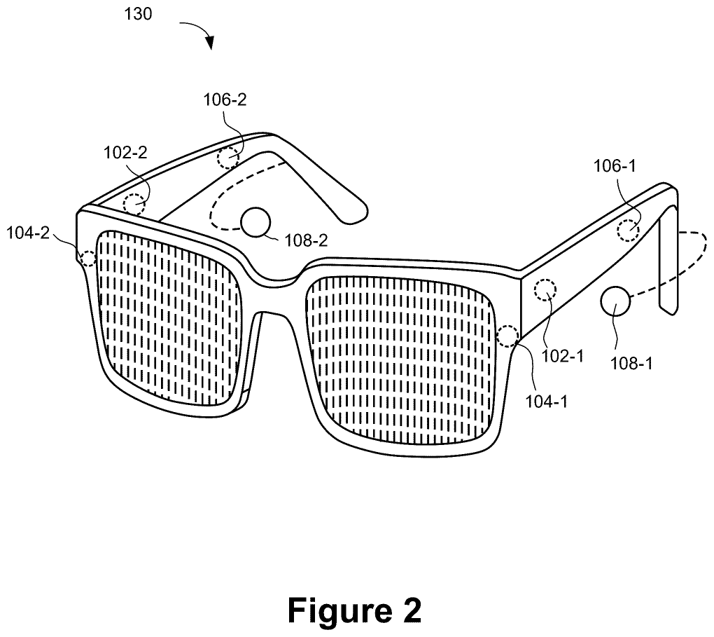

FIGS. 1A-1H illustrate the recognition of indistinctly quiet, inaudible, and imperceptible speech input of a wearable device, in accordance with some embodiments. For example, FIG. 1A illustrates a user 110 performing a speech input 150 that is recognized by a head-wearable device 130. The head-wearable device 130 may include one or more sensors (e.g., sensors 102-1, 102-2, 104-1, 104-2, 106-1, 106-2, 108-1, and 108-2, as shown in FIG. 2) configured to detect articulatory activity of the user 110, including biopotential sensors, contact microphones, acoustic microphones, IMU sensors, proximity sensors, ToF sensors, capacitive sensors, and strain sensors. Although FIG. 1A shows the user 110 wearing glasses, in other embodiments, other types of wearable devices may be used, such as an earbud 140, a headset, and/or smart textile-based garments configured to detect articulatory activity of the user 110. The wearable devices and electronic devices may be communicatively coupled via a network (e.g., cellular, near field, Wi-Fi, personal area network, wireless LAN).

The speech input 150 comprises various types of articulatory activity, ranging from overt speech to sub-vocal speech. In some embodiments, the speech input 150 includes a combination of the different types of sub-vocal speech. The head-wearable device 130 may select one or more sensors based on the type of articulatory activity and environmental conditions to accurately determine (recognize) the speech corresponding to the articulatory activity. In some embodiments, the articulatory activity comprises overt speech. Overt speech refers to articulatory activity in which the wearer's larynx is active and produces an audible sound at typical conversational volume levels. For example, overt speech may have an SNR of approximately 10 dB relative to background noise. In some embodiments, overt speech involves normal vocalization with vibration of the vocal cords, airflow through the vocal tract, and movement of the articulators including the tongue, lips, and jaw. In some embodiments, overt speech is detected using one or more acoustic microphones of the head-wearable device 130. In some embodiments, overt speech is detected using contact microphones, IMU sensors, and/or neuromuscular electrodes.

In some embodiments, the articulatory activity comprises soft speech. Soft speech refer to articulatory activity that produces audible sound at a volume level below typical conversational speech but above whispered speech levels. In some embodiments, soft speech has an SNR of approximately 3-6 dB relative to background noise. For example, the wearer's vocal cords may remain active during soft speech, but the wearer intentionally reduces the volume of vocalization. In some embodiments, soft speech is detected using one or more contact microphones (e.g., disposed in a nose bridge of the frame of the head-wearable device 130), which can be less susceptible to environmental noise interference as compared to acoustic microphones.

In some embodiments, the articulatory activity comprises whispered speech. Whispered speech may refer to articulatory activity without vocal cord vibration that produces minimal audible sound. In some embodiments, whispered speech has an SNR of approximately −6 to 0 dB relative to background noise. For example, whispered speech may involve airflow through the vocal tract and movement of the articulators without the periodic vibration of the vocal folds that characterize voiced speech. In some embodiments, whispered speech is detected using contact microphones embedded in the nose bridge of the frame of the head-wearable device 130, which can sense audio vibrations through contact with the wearer's face. In some embodiments, IMU sensors disposed in the head-wearable device 130 detect whispered speech by sensing vibrations and movements associated with speech production.

In some embodiments, the articulatory activity comprises mouthed speech. Mouthed speech may refer to articulatory activity involving visible mouth movement without airflow or audible sound. In some embodiments, no airflow is necessary during mouthed speech, which may allow the wearer to articulate faster than whispered speech. In some embodiments, mouthed speech has an SNR of negative infinity dB, indicating that no acoustic signal is produced. In some embodiments, mouthed speech involves the wearer moving the articulators (e.g., lips, tongue, jaw) in patterns associated with speech production without producing any acoustic output. Mouthed speech may be visually observable (e.g., an observer looking at the wearer would be able to see the mouth movements but would not be able to hear any sound). In some embodiments, mouthed speech is detected using neuromuscular electrodes that sense muscle contractions associated with articulatory movements, and/or using IMU sensors that detect subtle mechanical movements of the face and jaw.

In some embodiments, the articulatory activity comprises sub-vocal speech. Sub-vocal speech may refer to articulatory activity that does not produce audible sound and involves muscle contractions that may be imperceptible to visual observation. In some embodiments, sub-vocal speech involves muscle contractions of the muscles surrounding the jaw and the ear without producing audible sound. In some embodiments, sub-vocal speech is imperceptible (e.g., an observer is not able hear or see it). In some embodiments, sub-vocal speech has an SRN of negative infinity dB and is visually unobservable. In some embodiments, sub-vocal speech is detected using neuromuscular electrodes (e.g., disposed in temple arms of the frame of the head-wearable device 130 and configured to be proximate to the wearer's temples or in portions configured to rest behind the wearer's ears). The neuromuscular electrodes may detect electrical signals associated with contractions of facial muscles, including the masseter muscle that controls jaw movement, even when the wearer produces no visible or audible articulation.

In some embodiments, quiet speech refers to any speech produced at a volume level below typical conversational speech. In some embodiments, quiet speech includes whispered speech where there is no vibration of the speaker's vocal cords. In some embodiments, quiet speech includes speech below a particular volume, such as below a typical conversation level of 60 decibels, below 40 decibels, or below 30 decibels. Quiet speech may refer to speech having an SNR below a predetermined threshold with respect to background noise, such as below 10 dB SNR, below 5 dB SNR, or below 0 dB SNR. Quiet speech may encompass a spectrum of articulatory activity ranging from soft speech to whispered speech and may be characterized by reduced acoustic output that makes detection by conventional acoustic microphones challenging, particularly in noisy environments.

In some embodiments, the neuromuscular (e.g., EMG) electrodes are configured to address challenges associated with hair coverage on the wearer's head. Some electrode placements on the scalp or temple regions can be blocked by hair, which interferes with skin contact and degrades signal quality. To address this challenge, pogo pin electrodes may be used and configured to penetrate through the wearer's hair to achieve direct contact with the skin. The pogo pins may be configured to have a length and shape that allows them to pass between individual hair strands and press against the scalp or temple skin. In some embodiments, the pogo pins have a pointed or rounded tip that facilitates penetration through hair without causing discomfort to the wearer. The electrode boards may include multiple pogo pins arranged in an array, increasing the likelihood that at least some of the pogo pins achieve good skin contact even when the wearer has thick or dense hair. In some embodiments, the system monitors the impedance of each electrode channel and selects channels with lower impedance (indicating better skin contact) for signal acquisition.

In some embodiments, a machine-learning component (e.g., a gating neural network) is trained to filter out a variety of non-speech inputs that produce sensor signals similar to speech-related activity. Non-speech inputs may include chewing, coughing, sneezing, yawning, head motion, facial expressions, sighing, deep breaths, nodding, and shaking the head. The non-speech inputs can also include mechanical disturbances such as tapping the glasses, adjusting the fit of the wearable device, touching or bumping the frame, and wire or cable movement against the frame or the wearer's skin. The non-speech inputs can further include environmental sounds such as speech from other persons proximate to the wearer (side talk), background music, traffic noise, and other ambient sounds. The gating neural network may be trained on a dataset that includes examples of both speech inputs and non-speech inputs, enabling the network to learn the distinguishing characteristics of each. In some embodiments, the gating neural network uses sensor fusion, combining data from multiple sensor types (e.g., EMG electrodes, IMU sensors, contact microphones, acoustic microphones) to improve discrimination between speech and non-speech inputs. For example, if an acoustic microphone detects sound but an EMG electrode does not detect corresponding muscle activity, the gating neural network may determine that the sound is not from the wearer and filter it out. The gating neural network can achieve high accuracy in distinguishing between speech and non-speech inputs. For example, in some circumstances, the gating neural network can achieve approximately 95% accuracy, 95% precision, 88% recall, and 91% F1-score in detecting voice activity from the wearer.

Returning to FIGS. 1A and 1B, the user 110 wearing the head-wearable device 130 performs a speech input 150 (e.g., “Please text Steve to pack his soccer gear”) that is indistinctly quiet, inaudible, and/or imperceptible by a traditional microphone. In some embodiments, the speech input 150 comprises the user 110 mouthing the speech input 150 without producing audible sound. In some embodiments, one or more sensors detect muscle contractions associated with the speech input 150. In some embodiments, the head-wearable device 130 executes a command responsive to the speech input 150, such as drafting a text message to remind the user's contact to pack their soccer gear.

Turning to FIG. 1B, the user 110 performs speech input 150 without moving their mouth. In some embodiments, one or more sensors included with head-wearable device 130 detect muscle contractions associated with the speech input 150. In some embodiments, the muscle contractions are mouthed speech that is close to visually imperceptible. In some embodiments, no noise is associated with speech input 150. In some embodiments, the muscle contractions are sub-vocal that is visually imperceptible. In some embodiments, the head-wearable device 130 executes a command responsive to the speech input 150. For example, a user sitting in a quiet meeting may silently produce the speech input 150 (e.g., “set a reminder for 3 pm”) without any visible mouth movement, and the head-wearable device 130 may detect the muscle contractions associated with the speech input 150 and set a reminder on the user's calendar without disturbing others in the meeting.

Turning to FIG. 1C, in this example the user 110 is wearing head-wearable device 130 and earbud 140. In some embodiments, the user 110 is wearing only one of the head-wearable device 130 or the earbud 140. In some embodiments, the user 110 mouths the speech input 150 (e.g., “Remind me to buy groceries later”) that is indistinctly quiet, inaudible, and/or imperceptible by a traditional microphone. In some embodiments, the one or more sensors disposed in the head-wearable device 130 detect muscle contractions or vibrations associated with the speech input 150. The one or more sensors disposed in the head-wearable device 130 may include EMG electrodes, contact microphones, IMU sensors, and/or acoustic microphones. In some embodiments, the earbud 140 detects muscle contractions or vibrations associated with the speech input 150 using one or more sensors incorporated into the earbud 140. The one or more sensors incorporated into the earbud 140 may include EMG electrodes, contact microphones, IMU sensors, ultrasonic transceivers, and/or acoustic microphones. In some embodiments, the head-wearable device 130 and the earbud 140 are communicatively coupled via a network (e.g., cellular, near field, Wi-Fi, personal area network, wireless LAN), and the speech input 150 is determined based on sensor data from the head-wearable device 130, sensor data from the earbud 140, or a combination of sensor data from both devices. Based on the detected speech, the head-wearable device 130 or the earbud 140 executes a command responsive to the speech input 150, such as setting a reminder to buy groceries.

In FIG. 1D, the user 110 is wearing head-wearable device 130 and earbud 140. In some embodiments, the user 110 is wearing only one of the head-wearable device 130 or the earbud 140. In some embodiments, the user 110 performs speech input 150 without opening or moving their mouth. In some embodiments, the one or more sensors disposed in the head-wearable device 130 and/or the earbud 140 detect muscle contractions or vibrations associated with the speech input 150. The one or more sensors may include neuromuscular electrodes, contact microphones, IMU sensors, ultrasonic transceivers, and/or acoustic microphones. In some embodiments, the muscle contractions or vibrations detected by the one or more sensors are processed by a machine-learning model to determine what words, sounds, or noises the user 110 is conveying with speech input 150. The machine-learning model may be executed on the head-wearable device 130, the earbud 140, or another device communicatively coupled to the head-wearable device 130 or the earbud 140. In some embodiments, the machine-learning model performs feature extraction on the signals from the one or more sensors prior to classification. Feature extraction may include time-domain features such as signal amplitude, zero-crossing rate, and root mean square values, as well as frequency-domain features such as spectral power distribution and dominant frequency components. In some embodiments, the machine-learning model identifies one or more speech tokens from a closed set of candidate speech tokens, where the speech tokens may include commonly spoken words, phrases, or phonemes. For example, the closed set may include a vocabulary of 100 to 10,000 words or phrases that the user 110 has previously trained or that are pre-loaded on the head-wearable device 130. In some embodiments, the machine-learning model identifies speech from an open set, enabling the recognition of arbitrary words or phrases not previously encountered during training. In some embodiments, based on the detected speech and/or the determination performed by the machine-learning model, the head-wearable device 130 and/or the earbud 140 executes a command responsive to the speech input 150. For example, a user may silently mouth “play my workout playlist” while wearing both the head-wearable device 130 and the earbud 140, and in response, the head-wearable device 130 may display a visual confirmation of the command while the earbud 140 begins audio playback of the requested playlist.

In some embodiments, the machine-learning model is an artificially intelligent (AI) assistant on the head-wearable device 130 or another device communicatively coupled with head-wearable device 130. In some embodiments, the machine-learning model comprises a neural network architecture, such as a recurrent neural network (RNN), a long short-term memory (LSTM) network, a convolutional neural network (CNN), or a transformer model. In some embodiments, the machine-learning model is trained using previous muscle contractions performed by user 110 to determine the speech, words, or sounds user 110 is conveying when they perform muscle contractions without making audible sound. For example, during a calibration phase, the user 110 may be prompted to silently articulate a series of words or phrases while the sensors capture corresponding muscle contraction patterns, thereby creating user-specific training data that improves recognition accuracy. In some embodiments, the machine-learning model is only capable of determining preset commands or phrases that the user 110 is conveying when they perform muscle contractions without making audible sound. For example, the preset commands may include device control commands such as “play,” “pause,” “next,” “volume up,” or “answer call,” as well as text input commands for composing messages. In some embodiments, user 110 can add commands or phrases for the machine-learning model to recognize in future instances. In some embodiments, the machine-learning model employs transfer learning, where a base model trained on a large corpus of sub-vocal speech data is fine-tuned using user-specific data to improve recognition accuracy for the particular user 110. In some embodiments, the machine-learning model operates in conjunction with a language model that provides contextual information to improve recognition accuracy, such as predicting likely next words based on preceding words in a phrase. In some embodiments, the machine-learning model outputs a confidence score associated with each recognized word or phrase, and the head-wearable device 130 may request confirmation from the user 110 when the confidence score falls below a predetermined threshold.

The word error rate for utterance determination varies based on the type of articulatory activity. In one example, for a particular dataset, the word error rate for overt speech is approximately 6.6%, and the word error rate for soft speech is approximately 7.0%. For whispered speech, the word error rate may increase due to the reduced SNR, which may make it more difficult to distinguish speech signals from background noise. For mouthed speech and sub-vocal speech, the system may rely on neuromuscular electrodes and/or other non-acoustic sensors, and the word error rate may depend on factors such as the extent of user training, model personalization, sensor placement, and the consistency of the user's articulatory patterns. As the user trains the model with sample speech inputs and trains themselves to produce consistent articulatory patterns, the word error rate may decrease over time.

In some embodiments, the machine-learning model supports multiple languages for utterance determination. The model may be trained on speech data from multiple languages, enabling the system to recognize utterances in English, Spanish, French, German, Mandarin, and/or other languages. In some embodiments, the system detects the language of the wearer's utterance and applies a language-specific model and/or language-specific processing (e.g., to improve accuracy). In some embodiments, the system supports code-switching, where the wearer switches between languages within a single utterance or between consecutive utterances. For example, the system may identify the language of each speech segment and apply the appropriate language model. In some cases, the machine-learning model is a multilingual model trained on data from multiple languages, enabling the model to recognize utterances in any of the supported languages without requiring explicit language detection. In some embodiments, the wearer selects a preferred language or set of languages in the settings of the wearable device, and the system prioritizes recognition in the selected languages.

Turning to FIG. 1E, the user 110 is wearing head-wearable device 130. In some embodiments, the user 110 performs speech input 150 (e.g., “Please schedule an appointment for next week”) while moving their mouth. In some embodiments, the speech input 150 is whispered speech, where the user 110 speaks without vibrating their vocal cords, producing only faint airflow-based sounds. In some embodiments, the one or more sensors detect quiet speech associated with the speech input 150 using one or more contact microphones (e.g., embedded in the nose bridge of the head-wearable device 130). The contact microphones can sense audio vibrations transmitted through the user's nasal bone and facial structure, enabling the detection of whispered speech that is too quiet for acoustic microphones to reliably capture. In some embodiments, the contact microphones are treated as a separate input channel from acoustic microphones, and both channels are provided to the machine-learning model as a multi-channel input rather than fusing the signals together. In some embodiments, the quiet speech detected by the one or more contact microphones is processed by a machine-learning model to determine what words, sounds, or noises the user 110 is conveying with speech input 150. In some embodiments, IMU sensors are used in conjunction with the contact microphones, as IMU sensors function as vibration sensors and can capture complementary information about the user's speech activity.

Turning to FIG. 1F, the user 110 is wearing head-wearable device 130. In some embodiments, the user 110 performs speech input 150 without opening or moving their mouth, or with minimal visible movement. In some embodiments, the one or more sensors included with head-wearable device 130 detect muscle contractions associated with the speech input 150 using neuromuscular sensors disposed in the temple arms or behind-the-ear portions of the frame. In some embodiments, the neuromuscular sensors detect electrical signals from the masseter muscle (the large muscle that opens and closes the jaw) even when the user 110 produces no audible sound. In some embodiments, no noise is associated with speech input 150, and the SNR is effectively negative infinity dB. In some embodiments, one or more acoustic microphones are active and ready to detect speech from the user 110, but speech input 150 is not detectable by the one or more acoustic microphones because no airborne sound is produced. In some embodiments, the one or more acoustic microphones detect background noise, conversational noise, or other sounds not made by the user 110, and the speech input 150 is not confused with or otherwise mixed with the background noise because the neuromuscular sensors detect muscle activity that corresponds only to the user's own articulatory activity. In some embodiments, neuromuscular signals are used to disambiguate whispered speech or speech having a relatively low SNR, even when acoustic microphones are also active.

Turning to FIG. 1G, the user 110 is wearing head-wearable device 130. In some embodiments, the user 110 opens their mouth while an animal 160 (e.g., a dog) creates background noise 170 (e.g., barks). In some embodiments, one or more acoustic microphones included with the head-wearable device 130 detect the background noise 170, but the one or more sensors included with head-wearable device 130 (e.g., EMG electrodes, IMU sensors, contact microphones) do not detect muscle contractions, vibrations, or other indications of articulatory activity from the user 110. The head-wearable device 130 does not treat the background noise 170 as a speech input, despite the mouth of the user 110 being open. In some embodiments, the system uses sensor fusion to distinguish between the user's speech and environmental noise—if the acoustic microphone detects sound but the EMG electrodes and IMU sensors do not detect corresponding muscle activity or vibrations from the user's face, the system determines that the sound is not from the user 110 and filters it out. In some embodiments, this approach enables side-talk rejection, where the system distinguishes between the user's speech and speech from other people proximate to the user 110.

Turning to FIG. 1H, user 110 performs speech input 150 (e.g., “Remind me to buy groceries later”) while moving their mouth. In some embodiments, the one or more sensors included with head-wearable device 130 detect muscle contractions or vibrations associated with the speech input 150. The one or more sensors may include EMG electrodes, contact microphones, IMU sensors, and/or acoustic microphones. In some embodiments, the head-wearable device 130 determines the utterance by providing the sensor data to a trained machine-learning model, which identifies the speech tokens “remind me to buy groceries later” from the detected muscle contractions or vibrations. In some embodiments, the head-wearable device 130 executes a command 180 responsive to the speech input 150. The command 180 includes setting a reminder to buy groceries in the calendar of user 110 and presenting an audible output (e.g., “Got it, reminder set”) at one or more speakers of the head-wearable device 130. In some embodiments, the audible output is presented through bone conduction speakers or open-ear speakers that allow the user 110 to hear the confirmation while remaining aware of their surroundings. In some embodiments, the command 180 includes other actions such as sending a text message, initiating a phone call, controlling media playback, capturing an image, or providing the utterance to an AI assistant for further processing.

Although FIGS. 1A-1H illustrate examples with head-wearable device 130 as a pair of smart glasses, other types of wearable devices may be used to detect sub-vocal speech, quiet speech, or other articulatory activity. For example, the wearable device may be an earbud, a headband, a headset, a neckband, a throat-worn device, or other wearable device configured to contact a portion of the user's head, face, neck, or throat. The sensors described herein may be disposed at various locations on the wearable device to contact the user's skin and detect muscle contractions or vibrations associated with articulatory activity. For example, sensors may be disposed proximate to the user's temples, behind the user's ears, on the user's nose, around the user's ear canal, on the user's neck, or proximate to the user's throat. The types of sensors may include EMG electrodes, contact microphones, IMU sensors, acoustic microphones, ultrasonic transceivers, and/or other sensors capable of detecting muscle contractions, vibrations, or sounds associated with speech production. Additionally, although FIGS. 1A-1H illustrate a single user 110, the techniques described herein may be applied to multiple users, each wearing their own wearable device. Furthermore, although FIGS. 1A-1H illustrate specific speech inputs 150, the techniques described herein may be used to detect any type of speech input, including commands, queries, messages, or other utterances.

In some embodiments, the wearable devices may communicate using a body area network (BAN), where signals are transmitted between wearable devices using the user's body as the communication medium. For example, a pair of smart glasses and one or more earbuds may exchange data through electrical signals conducted through the user's skin or body tissue rather than through wireless radio frequency communication. In some cases, the BAN signals themselves may be used to detect articulatory activity associated with speech production. Movement of the user's jaw, facial muscles, or other articulators during speech may cause detectable variations in the BAN signals transmitted between wearable devices. For example, the system may compare BAN signals received at two earbuds worn in the user's left and right ears, or compare BAN signals transmitted between smart glasses and earbuds, to detect patterns indicative of speech-related movement. In this manner, the BAN communication channel may serve a dual purpose: facilitating data exchange between wearable devices and providing an additional sensing modality for detecting sub-vocal speech, quiet speech, or other articulatory activity. The BAN-based speech detection may be used alone or in combination with other sensors such as EMG electrodes, contact microphones, IMU sensors, or acoustic microphones to improve the accuracy of speech determination.

FIG. 2 illustrates head-wearable device 130. Head-wearable device 130 may include one or more sensors (e.g., sensors 102-1, 102-2, 104-1, 104-2, 106-1, 106-2, 108-1, and 108-2) configured to detect articulatory activity of the user 110, including biopotential sensors, contact microphones, acoustic microphones, IMU sensors, proximity sensors, ToF sensors, capacitive sensors, and strain sensors. In some embodiments, neuromuscular sensors (e.g., EMG sensors) may be positioned at various locations on the frame of the head-wearable device 130 to optimize the detection of different types of signals associated with articulatory activity. The neuromuscular sensors may be positioned to maintain contact with the user's skin to detect electrical signals from facial muscles. Referring to FIG. 2, neuromuscular sensors such as sensor 102-1 and sensor 102-2 may be positioned near the hinge area where the temple arms connect to the front frame, enabling the detection of electrical signals from the temporalis muscle during jaw movement. Sensor 104-1 and sensor 104-2 may be disposed at the outer corners of the frame to capture signals from facial muscles involved in speech production. Sensor 106-1 and sensor 106-2 may be positioned along the upper portion of the frame above the lenses, which may provide access to signals from the frontalis muscle and other muscles of the forehead region. Sensor 108-1 and sensor 108-2 may be disposed along the temple arms in portions configured to rest behind the wearer's ears, where they can detect signals from the masseter muscle, which is the primary muscle used for jaw clenching and chewing, and other muscles surrounding the jaw and ear that are active during speech. In some embodiments, sensors that are not positioned in contact with the user's skin, such as sensor 104-1 and sensor 104-2, are sensors such as acoustic microphones, ultrasonic transceivers, or other sensors that do not require direct skin contact to detect signals associated with articulatory activity.

In some embodiments, the sensors may be positioned on the inner surface of the temple arms to maintain consistent contact with the wearer's skin near the temporal region. Alternatively, sensors may be positioned on the nose bridge portion of the frame, where contact microphones can sense vibrations transmitted through the nasal bone during speech. Each placement location may be selected based on the type of biopotential signal being measured, such as EMG signals for detecting muscle contractions associated with sub-vocal speech. The sensor positioning may be adjustable or may include multiple electrode configurations to accommodate different head sizes and shapes while maintaining consistent skin contact. In some embodiments, pogo pin electrodes are used in portions of the frame that rest behind the wearer's ears, where the pogo pins are configured to penetrate through the wearer's hair to achieve direct contact with the skin, thereby addressing challenges associated with hair coverage that may interfere with signal quality.

Although FIG. 2 illustrates sensor placement on a pair of smart glasses, sensors for detecting sub-vocal speech, quiet speech, or other articulatory activity may be disposed at various locations on other types of wearable devices. For example, in an earbud, sensors may be disposed within the ear canal, on the outer housing of the earbud, or on a stem portion that extends toward the user's jaw, enabling the detection of muscle contractions or vibrations associated with speech production. In a headband or VR headset, sensors may be disposed along the portion of the device that contacts the user's forehead or temples, enabling the detection of signals from the frontalis muscle, temporalis muscle, or other facial muscles. In a neckband or throat-worn device, sensors may be disposed proximate to the user's larynx or along the sides of the neck, enabling the detection of vibrations or muscle activity associated with vocalization. In earphones with over-ear or on-ear configurations, sensors may be disposed on the ear cushions or headband to contact the user's skin proximate to the ears or temples. The types of sensors disposed on these wearable devices may include EMG electrodes, contact microphones, IMU sensors, acoustic microphones, ultrasonic transceivers, and/or other sensors capable of detecting muscle contractions, vibrations, or sounds associated with articulatory activity. The sensor placement and sensor types may be selected based on the form factor of the wearable device and the types of articulatory activity to be detected.

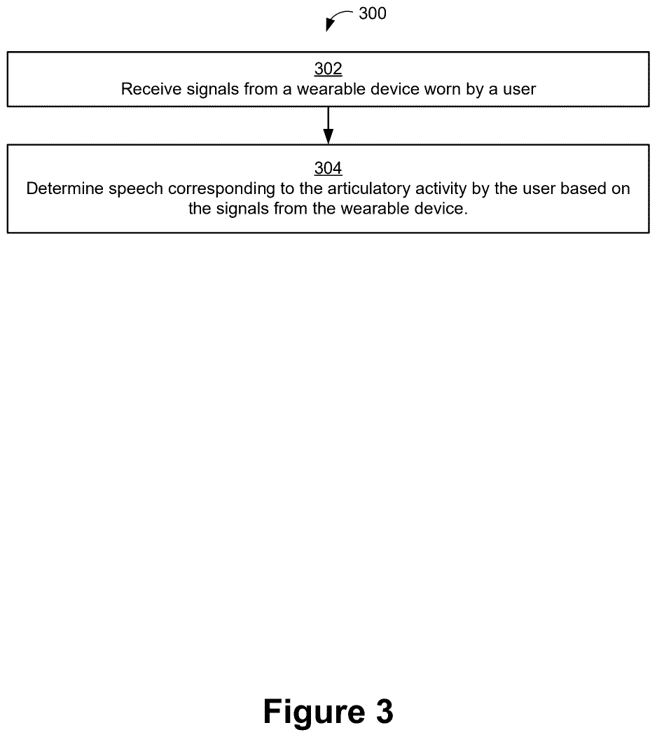

(A1) FIG. 3 illustrates a flow diagram of a method of detecting sub-vocal speech, in accordance with some embodiments. Operations (e.g., steps) of the method 300 can be performed by one or more processors (e.g., central processing unit and/or MCU) of a system such as at a head-wearable device (e.g., smart glasses) or another wearable device (e.g., a wrist-wearable device or one or more earbuds). At least some of the operations shown in FIG. 3 correspond to instructions stored in a computer memory or computer-readable storage medium (e.g., storage, RAM, and/or memory) at the head-wearable device. Operations of the method 300 can be performed by a single device alone or in conjunction with one or more processors and/or hardware components of another communicatively coupled device (e.g., ear-wearable device, wrist-wearable device, smartphone, etc.) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by a particular component or device, but should not be construed as limiting the performance of the operation to the particular device in all embodiments.

The method 300 includes, receiving (302) by one or more processors, signals from one or more sensors of a wearable device worn by a user, where the one or more sensors are configured to contact a head or face of the user and to detect at least one of the muscle contractions or vibrations associated with articulatory activity by the user, and determining (304) by the one or more processors, speech corresponding to the articulatory activity by the user based on the signals from the one or more sensors. For example, as shown in FIGS. 1A and 1B, a user 110 wearing a head-wearable device 130 can perform a speech input 150 without making airflow or making an audible sound (e.g., “Please text Steve to pack his soccer gear”) and head-wearable device 130 can determine speech activity corresponding to the speech input 150 by the user 110 based on signals from one or more sensors included with the head-wearable device 130.

In some embodiments, a wearable device includes multiple types of sensors for detecting articulatory activity from the wearer. The sensors may include EMG electrodes that detect electrical signals from facial muscles, contact microphones that sense vibrations through physical contact with the wearer's skin, IMU sensors that detect motion and vibration, and/or acoustic microphones that capture airborne sound. The system may analyze sensor data to determine characteristics of the wearer's speech activity, such as whether the wearer is speaking out loud, whispering, silently mouthing words, or engaging in sub-vocal speech with minimal visible movement of the mouth and/or face. The system may also assess environmental conditions, such as background noise levels or signal quality. Based on these characteristics, the system may intelligently select which sensors to rely upon for determining what the wearer is saying. For example, in a noisy subway or crowded coffee shop where acoustic microphones may pick up too much background noise, the system may instead rely on EMG electrodes or contact microphones that are not affected by and/or do not capture ambient sound. As another example, when the wearer is silently mouthing words without producing any sounds, such as when composing a private message in a quiet library, the system may rely on EMG electrodes that can detect the subtle muscle movements associated with speech production. As yet another example, when the wearer is whispering in a quiet environment, the system may rely on contact microphones embedded in the nose bridge of the wearable device, which can sense vibrations transmitted through the wearer's facial structure even when the speech is too quiet for acoustic microphones to capture reliably. In some cases, when EMG electrode contact quality is poor, such as when the wearer has thick hair covering the temple region or when the wearable device is not properly seated on the wearer's face, the system may rely on contact microphones or IMU sensors instead of EMG electrodes to determine the speech. This adaptive approach allows the system to accurately understand the wearer's intended speech across a wide range of situations, from normal conversation to completely silent input.

(A2) In some embodiments of A1, the articulatory activity comprises one or more of sub-vocal speech, mouthed speech, and whispered speech. In some embodiments, sub-vocal speech comprises articulatory activity that does not produce audible sound and involves muscle contractions (e.g., detectable via EMG), mouthed speech comprises articulatory activity involving visible mouth movement without airflow or audible sound, and whispered speech comprises articulatory activity without vocal cord vibration that produces minimal audible sound. For example, as shown in FIGS. 1A and 1B, a user 110 wearing a head-wearable device 130 can perform a speech input 150 without making airflow or making an audible sound (e.g., “Please text Steve to pack his soccer gear”) and head-wearable device 130 can determine speech activity corresponding to the speech input 150 by the user 110 based on signals from one or more sensors included with the head-wearable device 130.

In some embodiments, overt speech is defined as ~10 dB SNR, where the larynx is active (e.g., conversational volume), soft speech is defined as ~3-6 dB SNR (e.g., below overt speech but above whispered speech), whispered speech is defined as −6 to 0 dB SNR (e.g., no vocal cord vibration) and is detectable via contact microphones/IMU, mouthed speech is defined as −∞ dB SNR (e.g., visible mouth movement without sound) and is detectable via EMG/IMU, sub-vocal speech, which is defined as-∞dB SNR (e.g., imperceptible muscle contractions) and is detectable via EMG electrodes, and quiet speech, which is an umbrella term for speech below conversational level. As shown in FIGS. 1E and 1F, the distinction between whispered speech and sub-vocal speech is illustrated, where FIG. 1E depicts a user 110 whispering a speech input 150 that is picked up by a microphone, while FIG. 1F depicts the user 110 with mouth closed producing the same speech input 150 through sub-vocal articulation detected by the head-wearable device 130.

(A3) In some embodiments of any of A1 or A2, the method includes determining whether the articulatory activity corresponds to sub-vocal speech or quiet speech. In accordance with a determination that the articulatory activity corresponds to sub-vocal speech, selecting, by the one or more processors, a first set of one or more sensors as the one or more sensors. In accordance with a determination that the articulatory activity corresponds to quiet speech, selecting, by the one or more processors, a second set of one or more sensors as the one or more sensors. For example, as shown in FIGS. 1A and 1B, a user 110 wearing a head-wearable device 130 can perform a speech input 150 without making airflow or making an audible sound (e.g., “Please text Steve to pack his soccer gear”) and head-wearable device 130 can determine speech activity corresponding to the speech input 150 as well as whether to select a first set of one or more sensors based on the speech being sub-vocal (i.e., the user 110 does not open their mouth) or to select a second set of one or more sensors based on the speech being quiet (i.e., the user 110 opens their mouth) included with the head-wearable device 130.

In some embodiments, the system uses a tiered sensor activation approach (e.g., to conserve power and computational resources). One or more sensors—such as a contact microphone or acoustic microphone—may operate in a low-power, always-on monitoring mode to detect indications that the wearer may be attempting to speak. These always-on sensors may act as a “trigger” or “gatekeeper” that listens for potential speech activity. Responsive to detecting an indication of speech activity—such as vibrations consistent with jaw movement, airflow patterns associated with speech, or acoustic signals suggesting vocalization—the system may activate additional sensors for more detailed speech processing. For example, a contact microphone embedded in the nose bridge may continuously monitor for vibrations, and when vibrations consistent with speech are detected, the system may activate EMG electrodes and/or IMU sensors to capture additional data for determining the utterance. This approach allows power-intensive sensors and speech recognition processing to remain inactive until needed, extending battery life on the wearable device while still enabling responsive speech detection when the wearer begins speaking. In some embodiments, after the system determines that the wearer has finished speaking, the additional sensors are deactivated to further conserve power. The system may determine that the wearer has finished speaking based on a threshold amount of time during which no speech activity is detected, such as 1 second, 2 seconds, or 5 seconds of silence. Alternatively, the system may detect an end-of-utterance signal, such as a pause in muscle activity or a decrease in vibration amplitude below a predetermined threshold. Once the additional sensors are deactivated, the system may return to the low-power monitoring mode using the always-on sensors until the next indication of speech activity is detected.

In some embodiments, the system selects different sensors depending on how the wearer is speaking. Referring to FIG. 2, when the wearer is engaging in sub-vocal speech, the system may rely on EMG electrodes to detect the electrical activity in facial muscles. These EMG electrodes may be positioned along the temple arms of smart glasses or in portions that rest behind the wearer's ears, where they can pick up signals from muscles such as the masseter (which controls jaw movement) and the temporalis. When the wearer is whispering (e.g., speaking softly without engaging the vocal cords, producing only faint airflow-based sounds), the system may rely on contact microphones to detect the subtle vibrations. Contact microphones embedded in the nose bridge of smart glasses may sense vibrations transmitted through the wearer's nasal bone and facial structure, detecting whispered speech that would be too quiet for standard acoustic microphones to capture reliably. In this manner, the system may match the sensor to the speech type, using EMG for silent input and contact microphones for whispered input.

(A4) In some embodiments of A3, selecting the first set of one or more sensors or the second set of one or more sensors comprises selecting one or more neuromuscular electrodes responsive to determining that the user is producing the sub-vocal speech, and selecting one or more contact microphones responsive to determining that the user is producing the whispered speech. For example, as shown in FIGS. 1A and 1B, a user 110 wearing a head-wearable device 130 can perform a speech input 150 without making airflow or making an audible sound (e.g., “Please text Steve to pack his soccer gear”) and head-wearable device 130 can determine speech activity corresponding to the speech input 150 as well as whether to select a first set of one or more sensors (e.g., one or more neuromuscular electrodes) based on the speech being sub-vocal (e.g., the user 110 does not open their mouth) or to select a second set of one or more sensors (e.g., one or more contact microphones) based on the speech being quiet (e.g., the user 110 opens their mouth) included with the head-wearable device 130.

In some embodiments, the system continuously or periodically monitors sensor data to determine whether the wearer is engaging in speech-related activity. For example, one or more contact microphones or acoustic microphones may operate in a low-power monitoring mode to detect potential speech activity. In some cases, IMU sensors may be used to detect vibrations or movements associated with jaw motion or facial movement. Responsive to determining that no speech-related activity is present—for example, when the sensor data indicates the wearer is silent, idle, or not attempting to communicate—the system may refrain from performing utterance determination. As shown in FIG. 1G, this approach may reduce false activations triggered by non-speech inputs, such as background noise 170 from an animal 160, where the head-wearable device 130 does not treat the background noise as a speech input despite the mouth of the user 110 being open. By avoiding unnecessary speech recognition processing, the system may conserve battery power and computational resources on the wearable device. Additionally, limiting when speech recognition is active may address privacy concerns by ensuring the system is not continuously attempting to interpret the wearer's activity. In some embodiments, the system may use a lightweight binary classifier to distinguish between speech activity and non-speech activity. The classifier may be implemented as a small neural network having a relatively small number of parameters (e.g., less than 500,000 parameters) compared to full speech recognition models, enabling efficient always-on or near-always-on monitoring without significant power drain. In some cases, the system may use a tiered approach in which a first set of sensors operates in a low-power detection mode, and responsive to detecting potential speech activity, a second set of sensors is activated for more detailed processing.

(A5) In some embodiments of A1-A4, the method 300 includes prior to receiving the signals, detecting an indication of the articulatory activity by the user, and responsive to detecting the indication of the articulatory activity, activating at least one sensor of the one or more sensors. For example, as shown in FIGS. 1A and 1B, a user 110 wearing a head-wearable device 130 can indicate that they will perform a speech input 150 and can activate at least one sensor (e.g., an IMU) to detect the user 110 performing speech input 150 without the user 110 making airflow or making an audible sound (e.g., “Please text Steve to pack his soccer gear”) and head-wearable device 130 can determine speech activity corresponding to the speech input 150 by the user 110 based on signals from one or more sensors included with the head-wearable device 130.

(A6) In some embodiments of A5, the indication of the articulatory activity is detected via an IMU. For example, as shown in FIGS. 1A and 1B, a user 110 wearing a head-wearable device 130 can indicate that they will perform a speech input 150 and can activate at least one sensor (e.g., an IMU) to detect the user 110 performing speech input 150 without the user 110 making airflow or making an audible sound (e.g., “Please text Steve to pack his soccer gear”) and head-wearable device 130 can determine speech activity corresponding to the speech input 150 by the user 110 based on signals from one or more sensors included with the head-wearable device 130.

In some embodiments, after the system determines what the wearer is saying, the wearable device performs an action based on that utterance. For example, if the wearer silently mouths “call mom,” the smart glasses may initiate a phone call to a contact stored on a paired mobile device. If the wearer whispers “skip,” the smart glasses skip to the next song in a playlist. Other examples of commands include starting or pausing music playback, adjusting the volume, sending a text message, setting a reminder or timer, asking a question to an AI assistant, or navigating to a destination. As shown in FIG. 1H, the system may also provide feedback to the wearer indicating that the command has been received and executed. This approach allows the wearer to control the wearable device and interact with AI assistants without speaking out loud, which may be useful in public settings where the wearer prefers privacy, in quiet environments like libraries or meetings, or in noisy environments where spoken commands might not be heard clearly.

(A7) In some embodiments of A1-A6, the method includes, responsive to determining the speech, executing a command at the wearable device based on the speech. For example, as shown in FIG. 1H, a user 110 wearing a head-wearable device 130 can perform a speech input 150 without making airflow or making an audible sound (e.g., “Remind me to buy groceries later”) and head-wearable device 130 can determine speech activity corresponding to the speech input 150 by the user 110 based on signals from one or more sensors included with the head-wearable device 130 and can execute a command 180 based on the speech input 150, as indicated by the audio feedback displaying “Got it, reminder set.” In some embodiments, executing the command includes identifying an application associated with the determined speech and performing an action within that application. For example, responsive to determining that the speech includes “remind me” or “set a reminder,” the system may identify a calendar application or reminders application on the wearable device or a paired device and generate a new entry in the calendar or reminders application. As another example, responsive to determining that the speech includes “set a timer for five minutes,” the system may identify a clock application or timer application and initiate a countdown timer for the specified duration. As yet another example, responsive to determining that the speech includes “text mom I'm on my way,” the system may identify a messaging application, select the appropriate contact, and compose a message with the specified content. In this manner, the system may interpret the determined speech to identify the appropriate application and action, enabling the wearer to control various device functions through sub-vocal or quiet speech input.

In some embodiments, the system interprets the user's command to identify the action to be performed, the corresponding application or applications involved, and/or any other devices or contacts referenced in the command. For example, responsive to determining that the speech includes “text Steve I'm running late,” the system may identify the action as sending a text message, identify a messaging application as the corresponding application, and identify “Steve” as a contact stored on the wearable device or a paired device. In some cases, the system may be unable to interpret the user's command due to ambiguity, low confidence in the speech determination, and/or missing information. Responsive to being unable to interpret the command, the system may follow up with the user for clarification, such as by presenting an audible or visual prompt asking the user to repeat the command or provide additional details. In some embodiments, the system confirms the action with the user before performing it, such as by presenting a summary of the interpreted command and requesting confirmation from the user. For example, the system may present “Send ‘I'm running late’ to Steve?” and wait for the user to confirm or cancel the action. The processing of the user's command may be performed at the wearable device, or the command may be sent to a cloud server or other device for further processing. For example, the wearable device may perform initial speech determination locally and transmit the determined speech to a cloud server for natural language understanding and action identification, or the wearable device may perform all processing locally without transmitting data to external servers.

(A8) In some embodiments of A1-A7, the method includes receiving data from another wearable device communicatively coupled to the wearable device and data comprising sensor signals indicative of articulatory activity of the user, and the speech is further determined based on the data from the other wearable device. For example, as shown in FIGS. 1C and 1D, a user 110 wearing a head-wearable device 130 and an earbud 140 can perform a speech input 150 without making airflow or making an audible sound (e.g., “Remind me to buy groceries later”) and head-wearable device 130 and earbud 140 can determine speech activity corresponding to the speech input 150 by the user 110 based on signals from one or more sensors included with the head-wearable device 130.

In some embodiments, the wearer may use multiple wearable devices together—for example, a pair of smart glasses and one or more devices worn in or around the ear. As shown in FIGS. 1C and 1D, the user 110 wears both the head-wearable device 130 and the earbud 140. These devices may communicate with each other wirelessly, such as via Bluetooth or another short-range communication protocol, to share sensor data related to the wearer's speech activity. The smart glasses may receive sensor signals from the earbuds, or the earbuds may receive sensor signals from the smart glasses. The sensor data shared between devices may include EMG signals indicative of muscle contractions near the ear or jaw, IMU signals from accelerometers or gyroscopes that detect subtle movements when the wearer speaks (e.g., the slight shaking of the ears during speech), or contact microphone signals that capture vibrations transmitted through the wearer's skin or ear canal. Because the earbuds are positioned differently than the smart glasses—closer to the ear canal and jaw muscles—they may capture complementary information about the wearer's speech that the smart glasses alone might miss. By combining sensor data from both devices, the system may achieve more accurate utterance determination, particularly for quiet or sub-vocal speech where any single device may not capture enough information on its own. In some cases, the system may use data from one device to confirm or validate the utterance determined from the other device, providing redundancy and improving overall recognition accuracy. For example, if the smart glasses detect mouthed speech via EMG electrodes, the system may cross-check this against IMU data from the earbuds to verify that the wearer was indeed engaging in speech-related activity.

(A9) In some embodiments of A8, the other wearable device comprises an earbud, and the data comprises one or more of: neuromuscular signals, IMU signals, or contact microphone signals captured by sensors incorporated into the earbud. For example, as shown in FIGS. 1C and 1D, a user 110 wearing a head-wearable device 130 and an earbud 140 can perform a speech input 150 without making airflow or making an audible sound (e.g., “Remind me to buy groceries later”) and head-wearable device 130 and earbud 140 can determine speech activity corresponding to the speech input 150 by the user 110 based on signals from one or more sensors included with the head-wearable device 130 and the earbud 140. The earbud may include sensors such as neuromuscular electrodes that detect muscle activity near the ear and jaw, IMU sensors (accelerometers and gyroscopes) that detect subtle movements of the ear when the wearer speaks, or contact microphones that sense vibrations transmitted through the ear canal or earbud housing. By capturing sensor data from the earbud's position close to the jaw and ear canal, the system may obtain complementary speech-related signals that enhance the accuracy of utterance determination when combined with data from the head-wearable device 130.

(A10) In some embodiments of A1-A9, the method includes selecting the one or more sensors from a plurality of sensors based on an environmental noise level exceeding a predetermined threshold. For example, as shown in FIG. 1G, a user 110 wearing a head-wearable device 130 may have their mouth open but not be performing any speech input, and if one or more acoustic microphones included with the head-wearable device 130 detect background noise 170 (e.g., a loud barking noise) from an animal 160, the head-wearable device 130 does not attempt to detect the user 110 performing a speech input due to the decibel level of the background noise 170.

In some embodiments, the system assesses how noisy the wearer's surroundings are and adjusts which sensors it relies on accordingly. The system may use acoustic microphones or other sensors to measure the ambient noise level—for example, detecting sounds from traffic, crowds, machinery, music, or conversations happening nearby. As illustrated in FIG. 1G, if the noise level exceeds a certain threshold (e.g., background noise 170 from a dog 160), the system may determine that standard acoustic microphones are unlikely to reliably capture the wearer's speech because they would pick up too much background noise. In these loud environments, the system may instead rely on sensors that are not affected by airborne sound—such as EMG electrodes that detect muscle activity in the face and jaw, contact microphones that sense vibrations directly through the wearer's skin or the frame of the glasses, or IMU sensors that detect physical movements associated with speech. These sensors (e.g., sensor 102-1, sensor 102-2, sensor 104-1, sensor 104-2, sensor 106-1, sensor 106-2, sensor 108-1, sensor 108-2 as shown in FIG. 2) can “hear” the wearer's speech through physical contact or electrical signals rather than through the air, making them effective even when the environment is noisy. Conversely, in a quiet environment—such as a library, a private office, or a quiet room at home —the system may rely on acoustic microphones, which can capture speech clearly when there is little competing noise. By automatically switching between sensor types based on the noise level, the system can maintain accurate speech detection whether the wearer is in a quiet conference room or walking down a busy city street.

(A11) In some embodiments of A1-A10, the method includes determining an SNR for each of a plurality of sensors, and selecting the one or more sensors from the plurality of sensors based on the SNR. For example, as shown in FIG. 1G, a user 110 wearing a head-wearable device 130 may have their mouth open to perform a speech input, and if one or more acoustic microphones included with the head-wearable device 130 detect background noise 170 (e.g., a loud barking noise) from an animal 160, the head-wearable device 130 will not attempt to detect the user 110 performing a speech input using the one or more acoustic microphones due to the decibel level of the background noise 170.

In some embodiments, the system evaluates how clearly each sensor is picking up the wearer's speech compared to background noise—a measurement known as the SNR. For each sensor, the system may compare the strength of signals that appear to be related to the wearer's speech activity against the strength of unwanted noise (e.g., ambient sounds, electrical interference, or sensor self-noise). A sensor with a high SNR captures the wearer's speech clearly, while a sensor with a low SNR may struggle to distinguish speech from noise. Based on these measurements, the system may select the sensors that are performing best under the current conditions. For example, if the acoustic microphones have a low SNR because the wearer is in a noisy environment or speaking very quietly, the system may instead rely on EMG electrodes or contact microphones that may have a higher SNR under those conditions. Conversely, if the wearer is speaking at normal volume in a quiet room, the acoustic microphones may have the highest SNR and be selected for determining the utterance. Additionally, the system may evaluate the contact quality of surface contact sensors, such as EMG electrodes or contact microphones, and avoid relying on sensors with poor contact. For example, if the wearer has thick hair covering the temple region, the EMG electrodes may have high impedance or weak signal strength, indicating poor skin contact. In such cases, the system may instead rely on acoustic microphones, IMU sensors, or contact microphones disposed at locations with better skin contact, such as the nose bridge. Similarly, if clothing or accessories interfere with sensor contact at certain locations, the system may select alternative sensors that are not affected by the obstruction. This approach allows the system to dynamically choose the best-performing sensors in real time, adapting to changes in the wearer's speech volume, speech type, or surrounding environment.

(A12) In some embodiments of A1-A11, the method includes selecting the one or more sensors, the selection of the one or more sensors comprising selecting one or more acoustic microphones responsive to determining that the articulatory activity produces sound above a predetermined volume threshold, and selecting one or more neuromuscular electrodes responsive to determining that the articulatory activity produces sound below the predetermined volume threshold or produces no audible sound. For example, as shown in FIGS. 1A and 1B, a user 110 wearing a head-wearable device 130 can perform a speech input 150 without making airflow or making an audible sound (e.g., “Please text Steve to pack his soccer gear”) and head-wearable device 130 can determine that speech input 150 is below a predetermined volume threshold, and process the speech activity corresponding to the speech input 150 by the user 110 based on signals from one or more sensors included with the head-wearable device 130 based on the speech input 150 being below the predetermined volume threshold.

In some embodiments, the system selects sensors based on how loudly the wearer is speaking. If the wearer is speaking at a normal conversational volume—for example, above 60 decibels or with an SNR above 10 dB—the system may rely on acoustic microphones, which work well for capturing audible speech. However, if the wearer is speaking very quietly, whispering, mouthing words silently, or engaging in sub-vocal speech that produces little or no audible sound, acoustic microphones may not be effective. In these cases, the system may switch to EMG electrodes, which detect the electrical activity in facial muscles associated with speech production—even when no sound is produced. As shown in FIGS. 1E and 1F, the distinction between whispered speech (FIG. 1E) and sub-vocal speech (FIG. 1F) is illustrated, where the head-wearable device 130 detects the speech input 150 using different sensor modalities depending on whether audible sound is produced. Referring to FIG. 2, when the wearer silently mouths “send message” in a quiet library, the acoustic microphones would capture nothing, but EMG electrodes (e.g., sensor 102-1 and sensor 102-2) positioned along the temple arms or behind the ears could detect the muscle movements involved in forming those words. By automatically switching between acoustic microphones for louder speech and EMG electrodes for quieter or silent speech, the system can accurately understand the wearer across the full spectrum of speech volumes—from a normal conversation to completely silent input.

(A13) In some embodiments of A1-A12, determining the speech comprises providing the signals from the one or more sensors to a trained machine-learning model. Referring to FIG. 3, the method 300 includes determining speech corresponding to the articulatory activity by the user 302 based on the signals from the one or more sensors, which may involve providing the signals to a trained machine-learning model.

In some embodiments, the system may use a trained machine-learning model to interpret the sensor data and determine what the wearer is saying. The machine-learning model may be trained on large datasets of sensor signals paired with known words, phrases, or commands. For example, the model may learn to recognize the patterns in EMG signals that correspond to silently mouthing the word “yes,” the vibration patterns in contact microphone signals that correspond to whispering “call mom,” or the acoustic patterns that correspond to saying “play music” out loud. Referring to FIG. 2, the model may be trained separately for different sensor types—learning the unique characteristics of EMG signals, contact microphone signals, IMU signals, and acoustic microphone signals—or it may be trained on combined multi-sensor data. When the wearer speaks (or silently mouths words), the system provides the sensor data to the trained model, which outputs either a transcription of what the wearer said (e.g., converting the input into text) or a classification identifying which predefined command the wearer issued (e.g., “play music” or “volume up”).

The machine-learning model(s) may be implemented using various architectures, including RNNs, LSTM networks, CNNs, transformer models, or combinations thereof. In some embodiments, the machine-learning model may be lightweight enough to run directly on the wearable device without requiring a connection to external servers. In other embodiments, the wearable device may transmit the sensor data or extracted features to a cloud server or paired device for processing by a more computationally intensive model. In some cases, the system may use a hybrid approach, where a lightweight model on the wearable device performs initial processing or filtering, and a more powerful model on a cloud server or paired device performs final speech determination. The machine-learning model may be pre-trained on a general dataset and then fine-tuned using user-specific data to improve recognition accuracy for the particular wearer. In some embodiments, the system may employ continual learning, where the model is updated over time based on feedback from the wearer, such as corrections to misrecognized speech or confirmations of correctly recognized speech. In some cases, the machine-learning model may output a confidence score associated with each recognized word or phrase, and the system may request confirmation from the wearer or select alternative interpretations when the confidence score falls below a predetermined threshold.

(A14) In some embodiments of A1-A13, the one or more sensors are disposed in one or more of a nose bridge of a frame of the wearable device, temple arms of the frame, or a portion of the frame configured to rest behind an ear of the user. For example, as shown in FIG. 2, a head-wearable device 130 can include sensors disposed at various locations on the frame, including sensor 102-1 and sensor 102-2 positioned near the hinge area, sensor 104-1 and sensor 104-2 disposed at the outer corners of the frame, sensor 106-1 and sensor 106-2 positioned along the upper portion of the frame, and sensor 108-1 and sensor 108-2 disposed along the temple arms.

In some embodiments, the sensors may be positioned at specific locations on the frame of the smart glasses to optimize detection of the wearer's speech activity. Referring to FIG. 2, contact microphones may be embedded in the nose bridge of the glasses, where they rest against the wearer's nose and can sense vibrations transmitted through the nasal bone when the wearer speaks or whispers. This location provides good contact with the wearer's face and can pick up subtle vibrations that travel through the facial bones during speech. EMG electrodes (e.g., sensor 102-1 and sensor 102-2) may be positioned along the temple arms of the glasses—the portions that extend from the lenses toward the ears—where they can detect electrical signals from facial muscles such as the temporalis muscle, which is involved in jaw movement. Additional sensors (e.g., sensor 108-1 and sensor 108-2) may be positioned in the portions of the frame that rest behind the wearer's ears—where they can detect signals from the masseter muscle (the primary muscle used for chewing and jaw clenching) and other muscles surrounding the jaw and ear that are active during speech. IMU sensors, which detect motion and vibration, may be placed at various locations along the frame to capture the subtle physical movements of the wearer's head and face during speech. By strategically positioning different sensor types at locations optimized for their sensing modalities, the system can capture a comprehensive picture of the wearer's articulatory activity.

(A15) In some embodiments of A1-A14, determining the speech comprises identifying one or more speech tokens from a closed set of candidate speech tokens. Referring to FIG. 3, the method may determine speech corresponding to the articulatory activity by identifying one or more speech tokens from a closed set of candidate speech tokens, where the speech tokens may include commonly spoken words, phrases, or commands. In some embodiments, the closed set of candidate speech tokens may include a vocabulary of commonly used commands such as “play,” “pause,” “stop,” “next,” “previous,” “volume up,” “volume down,” “call,” “text,” “remind,” “timer,” or “search.” The closed set may also include frequently used phrases such as “what time is it,” “what's the weather,” or “navigate home.” In some cases, the closed set may be customizable by the wearer, allowing the wearer to add or remove speech tokens based on their preferences or usage patterns. In some embodiments, the closed set may include phonemes rather than words, enabling the system to recognize arbitrary words by combining recognized phonemes. In other embodiments, the system may identify speech from an open set, enabling recognition of arbitrary words or phrases not previously encountered during training.

(A16) In some embodiments of A1-A15, determining the speech comprises performing feature extraction on the signals from the one or more sensors. Referring to FIG. 3, the method 300 may perform feature extraction on the signals from the one or more sensors prior to providing extracted features to a trained machine-learning model for determining the speech corresponding to the articulatory activity. In some embodiments, feature extraction may include time-domain features such as signal amplitude, zero-crossing rate, root mean square values, and signal envelope. Feature extraction may also include frequency-domain features such as spectral power distribution, dominant frequency components, mel-frequency cepstral coefficients (MFCCs), and spectral centroid. In some cases, feature extraction may include time-frequency representations such as spectrograms or wavelet transforms. For EMG signals, feature extraction may include muscle activation patterns, signal variance, and inter-electrode correlation. For contact microphone or IMU signals, feature extraction may include vibration frequency, amplitude modulation, and temporal patterns associated with speech production. In some embodiments, the feature extraction may be performed by a dedicated signal processing module on the wearable device prior to providing the extracted features to the machine-learning model.

(A17) In some embodiments of A1-A16, the wearable device comprises a head-wearable device. In some embodiments, the head-wearable device may be a pair of smart glasses or AR glasses, an MR headset, a VR headset, or other eyewear configured to be worn on the wearer's head. In some embodiments, the head-wearable device may be an earbud, a pair of earbuds, over-ear headphones, on-ear headphones, or another ear-wearable device configured to be worn in, on, or around the wearer's ears. In some embodiments, the head-wearable device may be a headband, a hat, a helmet, or another head-worn accessory configured to contact the wearer's forehead, temples, or scalp. In some cases, the wearer may use multiple head-wearable devices together, such as a pair of smart glasses and one or more earbuds, and the devices may communicate with each other to share sensor data and improve speech determination.

In some embodiments, smart glasses may include sensors embedded in the frame—such as along the temple arms, in the nose bridge, or in portions that rest behind the ears—to detect the wearer's speech activity. A headset may include similar sensors positioned to contact the wearer's forehead, temples, or cheeks. Earbuds may include sensors positioned within the ear canal or on the outer housing to detect vibrations, muscle activity, or sounds associated with speech. In some cases, the wearer may use multiple head-wearable devices together—for example, wearing both smart glasses and earbuds—and the devices may communicate with each other to share sensor data and improve utterance determination. By positioning sensors on a head-wearable device, the system can place sensors in close proximity to the wearer's mouth, jaw, and facial muscles, enabling detection of speech-related activity including overt speech, whispered speech, mouthed speech, and sub-vocal speech.

(A18) In some embodiments of A1-A17, the one or more processors are communicatively coupled to the wearable device, and receiving the signals comprises receiving the signals from the wearable device via a communication link. In some embodiments, the one or more processors are disposed in another wearable device communicatively coupled to the wearable device. For example, a pair of smart glasses may transmit sensor signals to a wrist-wearable device, and the wrist-wearable device may process the sensor signals to determine the speech. In some embodiments, the one or more processors are disposed in a companion device, such as a smartphone, tablet, or laptop computer, that is communicatively coupled to the wearable device. For example, a pair of earbuds may transmit sensor signals to a paired smartphone via Bluetooth, and the smartphone may process the sensor signals to determine the speech. In some embodiments, the one or more processors are disposed in a remote server or cloud computing platform that is communicatively coupled to the wearable device via a network connection. For example, the wearable device may transmit sensor signals or extracted features to a cloud server via Wi-Fi or cellular connection, and the cloud server may process the data using more computationally intensive models than would be feasible on the wearable device itself. The communication link may include wired connections (e.g., USB, audio jack) or wireless connections (e.g., Bluetooth, Wi-Fi, cellular, near-field communication). In some cases, the wearable device may perform initial processing or feature extraction locally and transmit the processed data to the remote processors for final speech determination, thereby reducing bandwidth requirements and latency.

In accordance with some embodiments, a system includes one or more wearable devices, the one or more wearable devices comprising one or more sensors, and the system is configured to perform operations corresponding to any of A1-A18. In accordance with some embodiments, a non-transitory computer-readable storage medium includes instructions that, when executed by a computing device, cause the computer device to perform operations corresponding to any of A1-A18. In accordance with some embodiments, a method of operating a pair of smart glasses includes operations that correspond to any of A1-A18.

The devices described above are further detailed below, including wrist-wearable devices, headset devices, systems, and haptic feedback devices. Specific operations described above may occur as a result of specific hardware, and such hardware is described in further detail below. The devices described below are not limiting and features on these devices can be removed or additional features can be added to these devices.

### Example Extended-Reality Systems

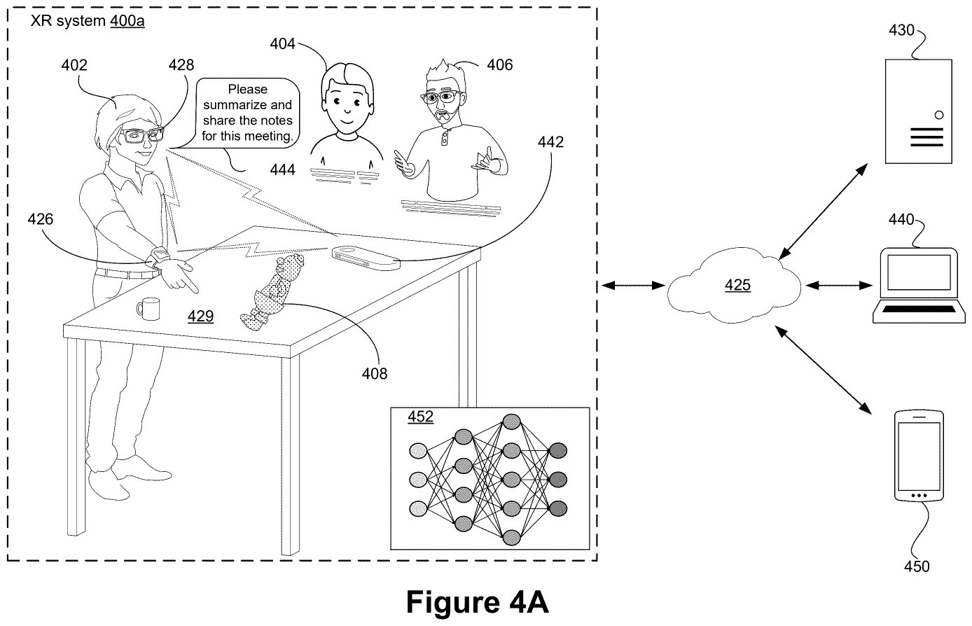

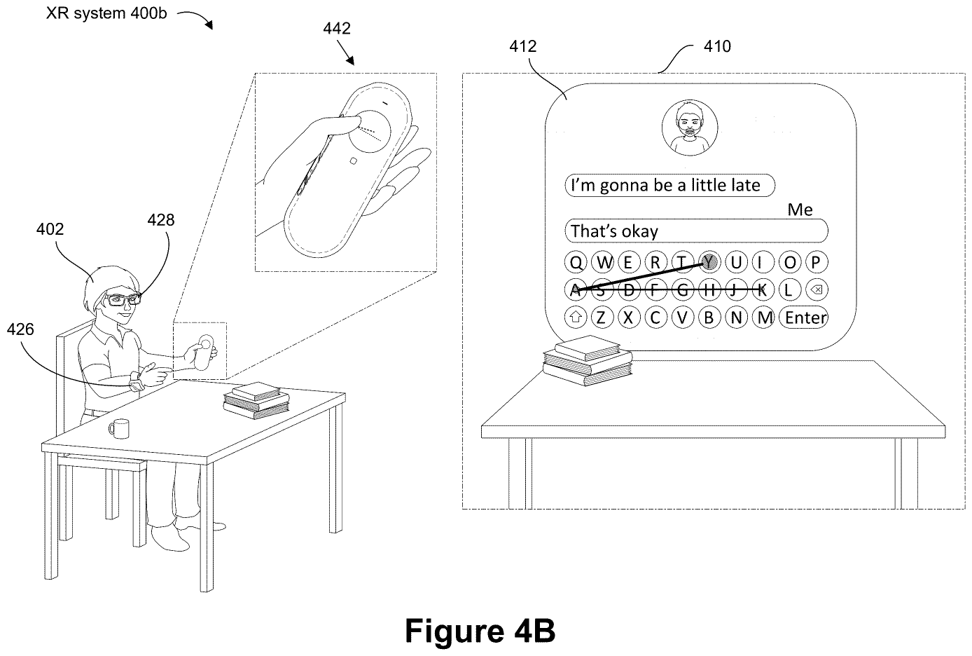

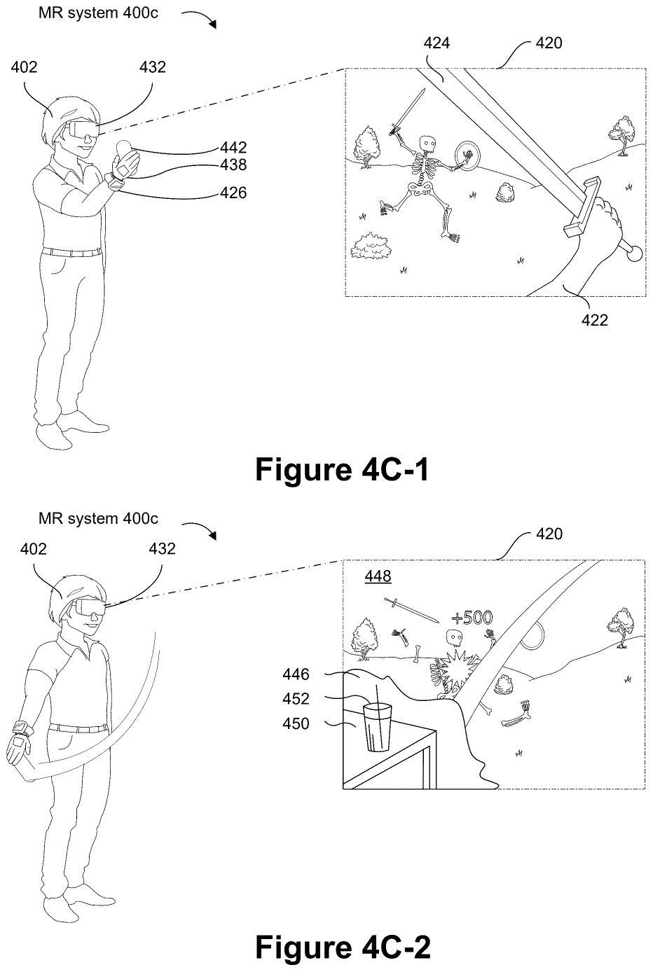

FIGS. 4A, 4B, 4C-1, and 4C-2, illustrate example XR systems that include AR and MR systems, in accordance with some embodiments. FIG. 4A shows a first XR system 400a and first example user interactions using a wrist-wearable device 426, a head-wearable device (e.g., AR device 428), and/or a HIPD 442. FIG. 4B shows a second XR system 400b and second example user interactions using a wrist-wearable device 426, AR device 428, and/or an HIPD 442. FIGS. 4C-1 and 4C-2 show a third MR system 400c and third example user interactions using a wrist-wearable device 426, a head-wearable device (e.g., an MR device such as a VR device), and/or an HIPD 442. As the skilled artisan will appreciate upon reading the descriptions provided herein, the above-example AR and MR systems (described in detail below) can perform various functions and/or operations.

The wrist-wearable device 426, the head-wearable devices, and/or the HIPD 442 can communicatively couple via a network 425 (e.g., cellular, near field, Wi-Fi, personal area network, wireless LAN). Additionally, the wrist-wearable device 426, the head-wearable device, and/or the HIPD 442 can also communicatively couple with one or more servers 430, computers 440 (e.g., laptops, computers), mobile devices 450 (e.g., smartphones, tablets), and/or other electronic devices via the network 425 (e.g., cellular, near field, Wi-Fi, personal area network, wireless LAN). Similarly, a smart textile-based garment, when used, can also communicatively couple with the wrist-wearable device 426, the head-wearable device(s), the HIPD 442, the one or more servers 430, the computers 440, the mobile devices 450, and/or other electronic devices via the network 425 to provide inputs.

Turning to FIG. 4A, a user 402 is shown wearing the wrist-wearable device 426 and the AR device 428 and having the HIPD 442 on their desk. The wrist-wearable device 426, the AR device 428, and the HIPD 442 facilitate user interaction with an AR environment. In particular, as shown by the first AR system 400a, the wrist-wearable device 426, the AR device 428, and/or the HIPD 442 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 426, the AR device 428, and/or the HIPD 442. In addition, the user 402 is also able to directly view physical objects in the environment, such as a physical table 429, through transparent lens(es) and waveguide(s) of the AR device 428. Alternatively, an MR device could be used in place of the AR device 428 and a similar user experience can take place, but the user would not be directly viewing physical objects in the environment, such as table 429, and would instead be presented with a virtual reconstruction of the table 429 produced from one or more sensors of the MR device (e.g., an outward facing camera capable of recording the surrounding environment).

The user 402 can use any of the wrist-wearable device 426, the AR device 428 (e.g., through physical inputs at the AR device and/or built-in motion tracking of a user's extremities), a smart-textile garment, externally mounted extremity tracking device, the HIPD 442 to provide user inputs, etc. For example, the user 402 can perform one or more hand gestures that are detected by the wrist-wearable device 426 (e.g., using one or more EMG sensors and/or IMUs built into the wrist-wearable device) and/or AR device 428 (e.g., using one or more image sensors or cameras) to provide a user input. Alternatively, or additionally, the user 402 can provide a user input via one or more touch surfaces of the wrist-wearable device 426, the AR device 428, and/or the HIPD 442, and/or voice commands captured by a microphone of the wrist-wearable device 426, the AR device 428, and/or the HIPD 442. The wrist-wearable device 426, the AR device 428, and/or the HIPD 442 include an artificially intelligent digital assistant to help the user in providing a user input (e.g., completing a sequence of operations, suggesting different operations or commands, providing reminders, confirming a command). For example, the digital assistant can be invoked through an input occurring at the AR device 428 (e.g., via an input at a temple arm of the AR device 428). In some embodiments, the user 402 can provide a user input via one or more facial gestures and/or facial expressions. For example, cameras of the wrist-wearable device 426, the AR device 428, and/or the HIPD 442 can track the user 402's eyes for navigating a user interface.

The wrist-wearable device 426, the AR device 428, and/or the HIPD 442 can operate alone or in conjunction to allow the user 402 to interact with the AR environment. In some embodiments, the HIPD 442 is configured to operate as a central hub or control center for the wrist-wearable device 426, the AR device 428, and/or another communicatively coupled device. For example, the user 402 can provide an input to interact with the AR environment at any of the wrist-wearable device 426, the AR device 428, and/or the HIPD 442, and the HIPD 442 can identify one or more back-end and front-end tasks to cause the performance of the requested interaction and distribute instructions to cause the performance of the one or more back-end and front-end tasks at the wrist-wearable device 426, the AR device 428, and/or the HIPD 442. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 442 can perform the back-end tasks and provide the wrist-wearable device 426 and/or the AR device 428 operational data corresponding to the performed back-end tasks such that the wrist-wearable device 426 and/or the AR device 428 can perform the front-end tasks. In this way, the HIPD 442, which has more computational resources and greater thermal headroom than the wrist-wearable device 426 and/or the AR device 428, performs computationally intensive tasks and reduces the computer resource utilization and/or power usage of the wrist-wearable device 426 and/or the AR device 428.

In the example shown by the first AR system 400a, the HIPD 442 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 442 performs back-end tasks for processing and/or rendering image data (and other data) associated with the AR video call and provides operational data associated with the performed back-end tasks to the AR device 428 such that the AR device 428 performs front-end tasks for presenting the AR video call (e.g., presenting the avatar 404 and the digital representation of the contact 406).

In some embodiments, the HIPD 442 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 442. In particular, the HIPD 442 and the AR device 428 operate in conjunction to determine a location for presenting the avatar 404 and the digital representation of the contact 406. In some embodiments, information can be presented within a predetermined distance from the HIPD 442 (e.g., within five meters). For example, as shown in the first AR system 400a, virtual object 408 is presented on the desk some distance from the HIPD 442. Similar to the above example, the HIPD 442 and the AR device 428 can operate in conjunction to determine a location for presenting the virtual object 408. Alternatively, in some embodiments, presentation of information is not bound by the HIPD 442. More specifically, the avatar 404, the digital representation of the contact 406, and the virtual object 408 do not have to be presented within a predetermined distance of the HIPD 442. While an AR device 428 is described working with an HIPD, an MR headset can be interacted with in the same way as the AR device 428.

User inputs provided at the wrist-wearable device 426, the AR device 428, and/or the HIPD 442 are coordinated such that the user can use any device to initiate, continue, and/or complete an operation. For example, the user 402 can provide a user input to the AR device 428 to cause the AR device 428 to present the virtual object 408 and, while the virtual object 408 is presented by the AR device 428, the user 402 can provide one or more hand gestures via the wrist-wearable device 426 to interact and/or manipulate the virtual object 408. While an AR device 428 is described working with a wrist-wearable device 426, an MR headset can be interacted with in the same way as the AR device 428.

### Integration of Artificial Intelligence with XR Systems

FIG. 4A illustrates an interaction in which an artificially intelligent virtual assistant can assist in requests made by a user 402. The AI virtual assistant can be used to complete open-ended requests made through natural language inputs by a user 402. For example, in FIG. 4A the user 402 makes an audible request 444 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 4A also illustrates an example neural network 452 used in Artificial Intelligence applications. Uses of Artificial Intelligence (AI) are varied and encompass many different aspects of the devices and systems described herein. AI capabilities cover a diverse range of applications and deepen interactions between the user 402 and user devices (e.g., the AR device 428, an MR device 432, the HIPD 442, the wrist-wearable device 426). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 402 can interact with an AI model through natural language inputs captured by a voice sensor, text inputs, or any other input modality that accepts natural language and/or a corresponding voice sensor module. In another instance, input is provided by tracking the eye gaze of a user 402 via a gaze tracker module. Additionally, the AI model can also receive inputs beyond those supplied by a user 402. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 428) or from multiple devices that are in communication with each other (e.g., a system that includes at least two of an AR device 428, an MR device 432, the HIPD 442, the wrist-wearable device 426, etc.). The AI model can also access additional information (e.g., one or more servers 430, the computers 440, the mobile devices 450, and/or other electronic devices) via a network 425.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 428, an MR device 432, the HIPD 442, the wrist-wearable device 426) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 428, an MR device 432, the HIPD 442, the wrist-wearable device 426), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 442), haptic feedback can provide information to the user 402. An AI model can also use the inputs described above to determine the appropriate modality and device(s) to present content to the user (e.g., a user walking on a busy road can be presented with an audio output instead of a visual output to avoid distracting the user 402).

### Example Augmented Reality Interaction

FIG. 4B shows the user 402 wearing the wrist-wearable device 426 and the AR device 428 and holding the HIPD 442. In the second AR system 400b, the wrist-wearable device 426, the AR device 428, and/or the HIPD 442 are used to receive and/or provide one or more messages to a contact of the user 402. In particular, the wrist-wearable device 426, the AR device 428, and/or the HIPD 442 detect and coordinate one or more user inputs to initiate a messaging application and prepare a response to a received message via the messaging application.

In some embodiments, the user 402 initiates, via a user input, an application on the wrist-wearable device 426, the AR device 428, and/or the HIPD 442 that causes the application to initiate on at least one device. For example, in the second AR system 400b the user 402 performs a hand gesture associated with a command for initiating a messaging application (represented by messaging user interface 412); the wrist-wearable device 426 detects the hand gesture; and, based on a determination that the user 402 is wearing the AR device 428, causes the AR device 428 to present a messaging user interface 412 of the messaging application. The AR device 428 can present the messaging user interface 412 to the user 402 via its display (e.g., as shown by user 402's field of view 410). In some embodiments, the application is initiated and can be run on the device (e.g., the wrist-wearable device 426, the AR device 428, and/or the HIPD 442) that detects the user input to initiate the application, and the device provides another device operational data to cause the presentation of the messaging application. For example, the wrist-wearable device 426 can detect the user input to initiate a messaging application, initiate and run the messaging application, and provide operational data to the AR device 428 and/or the HIPD 442 to cause presentation of the messaging application. Alternatively, the application can be initiated and run at a device other than the device that detected the user input. For example, the wrist-wearable device 426 can detect the hand gesture associated with initiating the messaging application and cause the HIPD 442 to run the messaging application and coordinate the presentation of the messaging application.

Further, the user 402 can provide a user input provided at the wrist-wearable device 426, the AR device 428, and/or the HIPD 442 to continue and/or complete an operation initiated at another device. For example, after initiating the messaging application via the wrist-wearable device 426 and while the AR device 428 presents the messaging user interface 412, the user 402 can provide an input at the HIPD 442 to prepare a response (e.g., shown by the swipe gesture performed on the HIPD 442). The user 402's gestures performed on the HIPD 442 can be provided and/or displayed on another device. For example, the user 402's swipe gestures performed on the HIPD 442 are displayed on a virtual keyboard of the messaging user interface 412 displayed by the AR device 428.

In some embodiments, the wrist-wearable device 426, the AR device 428, the HIPD 442, and/or other communicatively coupled devices can present one or more notifications to the user 402. The notification can be an indication of a new message, an incoming call, an application update, a status update, etc. The user 402 can select the notification via the wrist-wearable device 426, the AR device 428, or the HIPD 442 and cause presentation of an application or operation associated with the notification on at least one device. For example, the user 402 can receive a notification that a message was received at the wrist-wearable device 426, the AR device 428, the HIPD 442, and/or other communicatively coupled device and provide a user input at the wrist-wearable device 426, the AR device 428, and/or the HIPD 442 to review the notification, and the device detecting the user input can cause an application associated with the notification to be initiated and/or presented at the wrist-wearable device 426, the AR device 428, and/or the HIPD 442.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 428 can present to the user 402 game application data and the HIPD 442 can use a controller to provide inputs to the game. Similarly, the user 402 can use the wrist-wearable device 426 to initiate a camera of the AR device 428, and the user can use the wrist-wearable device 426, the AR device 428, and/or the HIPD 442 to manipulate the image capture (e.g., zoom in or out, apply filters) and capture image data.

While an AR device 428 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 4C-1 and 4C-2, the user 402 is shown wearing the wrist-wearable device 426 and an MR device 432 (e.g., a device capable of providing either an entirely VR experience or an MR experience that displays object(s) from a physical environment at a display of the device) and holding the HIPD 442. In the third AR system 400c, the wrist-wearable device 426, the MR device 432, and/or the HIPD 442 are used to interact within an MR environment, such as a VR game or other MR/VR application. While the MR device 432 presents a representation of a VR game (e.g., first MR game environment 420) to the user 402, the wrist-wearable device 426, the MR device 432, and/or the HIPD 442 detect and coordinate one or more user inputs to allow the user 402 to interact with the VR game.

In some embodiments, the user 402 can provide a user input via the wrist-wearable device 426, the MR device 432, and/or the HIPD 442 that causes an action in a corresponding MR environment. For example, the user 402 in the third MR system 400c (shown in FIG. 4C-1) raises the HIPD 442 to prepare for a swing in the first MR game environment 420. The MR device 432, responsive to the user 402 raising the HIPD 442, causes the MR representation of the user 422 to perform a similar action (e.g., raise a virtual object, such as a virtual sword 424). In some embodiments, each device uses respective sensor data and/or image data to detect the user input and provide an accurate representation of the user 402's motion. For example, image sensors (e.g., SLAM cameras or other cameras) of the HIPD 442 can be used to detect a position of the HIPD 442 relative to the user 402's body such that the virtual object can be positioned appropriately within the first MR game environment 420; sensor data from the wrist-wearable device 426 can be used to detect a velocity at which the user 402 raises the HIPD 442 such that the MR representation of the user 422 and the virtual sword 424 are synchronized with the user 402's movements; and image sensors of the MR device 432 can be used to represent the user 402's body, boundary conditions, or real-world objects within the first MR game environment 420.

In FIG. 4C-2, the user 402 performs a downward swing while holding the HIPD 442. The user 402's downward swing is detected by the wrist-wearable device 426, the MR device 432, and/or the HIPD 442 and a corresponding action is performed in the first MR game environment 420. In some embodiments, the data captured by each device is used to improve the user's experience within the MR environment. For example, sensor data of the wrist-wearable device 426 can be used to determine a speed and/or force at which the downward swing is performed and image sensors of the HIPD 442 and/or the MR device 432 can be used to determine a location of the swing and how it should be represented in the first MR game environment 420, which, in turn, can be used as inputs for the MR environment (e.g., game mechanics, which can use detected speed, force, locations, and/or aspects of the user 402's actions to classify a user's inputs (e.g., user performs a light strike, hard strike, critical strike, glancing strike, miss) or calculate an output (e.g., amount of damage)).

FIG. 4C-2 further illustrates that a portion of the physical environment is reconstructed and displayed at a display of the MR device 432 while the MR game environment 420 is being displayed. In this instance, a reconstruction of the physical environment 446 is displayed in place of a portion of the MR game environment 420 when object(s) in the physical environment are potentially in the path of the user (e.g., a collision with the user and an object in the physical environment are likely). Thus, this example MR game environment 420 includes (i) an immersive VR portion 448 (e.g., an environment that does not have a corollary counterpart in a nearby physical environment) and (ii) a reconstruction of the physical environment 446 (e.g., table 450 and cup 452). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 426, the MR device 432, and/or the HIPD 442 are described as detecting user inputs, in some embodiments, user inputs are detected at a single device (with the single device being responsible for distributing signals to the other devices for performing the user input). For example, the HIPD 442 can operate an application for generating the first MR game environment 420 and provide the MR device 432 with corresponding data for causing the presentation of the first MR game environment 420, as well as detect the user 402's movements (while holding the HIPD 442) to cause the performance of corresponding actions within the first MR game environment 420. Additionally or alternatively, in some embodiments, operational data (e.g., sensor data, image data, application data, device data, and/or other data) of one or more devices is provided to a single device (e.g., the HIPD 442) to process the operational data and cause respective devices to perform an action associated with processed operational data.

In some embodiments, the user 402 can wear a wrist-wearable device 426, wear an MR device 432, wear smart textile-based garments 438 (e.g., wearable haptic gloves), and/or hold an HIPD 442 device. In this embodiment, the wrist-wearable device 426, the MR device 432, and/or the smart textile-based garments 438 are used to interact within an MR environment (e.g., any AR or MR system described above in reference to FIGS. 4A-4B). While the MR device 432 presents a representation of an MR game (e.g., second MR game environment 420) to the user 402, the wrist-wearable device 426, the MR device 432, and/or the smart textile-based garments 438 detect and coordinate one or more user inputs to allow the user 402 to interact with the MR environment.

In some embodiments, the user 402 can provide a user input via the wrist-wearable device 426, an HIPD 442, the MR device 432, and/or the smart textile-based garments 438 that causes an action in a corresponding MR environment. In some embodiments, each device uses respective sensor data and/or image data to detect the user input and provide an accurate representation of the user 402's motion. While four different input devices are shown (e.g., a wrist-wearable device 426, an MR device 432, an HIPD 442, and a smart textile-based garment 438) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 438) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 438 can be used in conjunction with an MR device and/or an HIPD 442.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions are possible with other devices. For example, a user can interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots are also able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described are more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein can be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 4A-4C-2 provided above are intended to augment the description provided in reference to FIGS. 1A-2. While terms in the following description are not identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of detecting speech, comprising:
receiving, by one or more processors, signals from one or more sensors of a wearable device worn by a user, wherein the one or more sensors are configured to contact a head or face of the user and to detect at least one of muscle contractions or vibrations associated with articulatory activity by the user; and
determining, by the one or more processors, speech corresponding to the articulatory activity by the user based on the signals from the one or more sensors.

2. The method of claim 1, wherein the articulatory activity comprises one or more of sub-vocal speech, mouthed speech, and whispered speech.

3. The method of claim 2, further comprising:
determining whether the articulatory activity corresponds to sub-vocal speech or quiet speech;
in accordance with a determination that the articulatory activity corresponds to sub-vocal speech, selecting, by the one or more processors, a first set of one or more sensors as the one or more sensors; and
in accordance with a determination that the articulatory activity corresponds to quiet speech, selecting, by the one or more processors, a second set of one or more sensors as the one or more sensors.

4. The method of claim 3, wherein selecting the first set of one or more sensors or the second set of one or more sensors comprises:
selecting one or more neuromuscular electrodes responsive to determining that the user is producing the sub-vocal speech; and
selecting one or more contact microphones responsive to determining that the user is producing the whispered speech.

5. The method of claim 1, further comprising:
prior to receiving the signals from the one or more sensors of the wearable device, detecting an indication of the articulatory activity by the user; and
responsive to detecting the indication of the articulatory activity, activating at least one sensor of the one or more sensors.

6. The method of claim 5, wherein the indication of the articulatory activity is detected via an inertial measurement unit (IMU).

7. The method of claim 1, further comprising:
responsive to determining the speech, executing a command at the wearable device based on the speech.

8. The method of claim 1, further comprising:
receiving data from another wearable device communicatively coupled to the wearable device, wherein:
the data comprises sensor signals indicative of articulatory activity of the user; and
the speech is further determined based on the data from the other wearable device.

9. The method of claim 8, wherein the other wearable device comprises an earbud, and wherein the data comprises one or more of: neuromuscular signals, IMU signals, or contact microphone signals captured by sensors incorporated into the earbud.

10. The method of claim 1, further comprising selecting the one or more sensors from a plurality of sensors based on an environmental noise level exceeding a predetermined threshold.

11. The method of claim 1, further comprising:
determining a signal-to-noise ratio for each of a plurality of sensors; and
selecting the one or more sensors from the plurality of sensors based on the signal-to-noise ratio.

12. The method of claim 1, further comprising selecting the one or more sensors, wherein selecting the one or more sensors comprises:
selecting one or more acoustic microphones responsive to determining that the articulatory activity produces sound above a predetermined volume threshold; and
selecting one or more neuromuscular electrodes responsive to determining that the articulatory activity produces sound below the predetermined volume threshold or produces no audible sound.

13. The method of claim 1, wherein determining the speech comprises providing the signals from the one or more sensors to a trained machine-learning model.

14. The method of claim 1, wherein the one or more sensors are disposed in one or more of a nose bridge of a frame of the wearable device, temple arms of the frame, or a portion of the frame configured to rest behind an ear of the user.

15. The method of claim 1, wherein determining the speech comprises identifying one or more speech tokens from a closed set of candidate speech tokens.

16. The method of claim 1, wherein determining the speech comprises performing feature extraction on the signals from the one or more sensors.

17. The method of claim 1, wherein the wearable device comprises a head-wearable device.

18. The method of claim 1, wherein the one or more processors are communicatively coupled to the wearable device, and wherein receiving the signals from the one or more sensors of the wearable device comprises receiving the signals from the wearable device via a communication link.

19. A system comprising:
one or more wearable devices configured to be worn by a user, the one or more wearable devices comprising one or more sensors configured to contact a head or face of the user and to detect at least one of muscle contractions or vibrations associated with articulatory activity by the user; and
one or more processors configured to:
receive signals from the one or more sensors; and
determine speech corresponding to the articulatory activity of the user based on the signals from the one or more sensors.

20. A non-transitory computer-readable medium storing instructions that, when executed by one or more processors of a wearable device, cause the one or more processors to perform operations comprising:
receiving signals from one or more sensors of the wearable device, wherein the one or more sensors are configured to contact a head or face of a user and to detect at least one of muscle contractions or vibrations associated with articulatory activity by the user; and
determining speech corresponding to the articulatory activity the user based on the signals from the one or more sensors.
